(19) United States
(12) Patent Application Publication
(10) Pub. No.: US 2017/0178233 A1
(43) Pub. Date: Jun. 22, 2017

(54) Tick Size Sequences Having Non-Linear Scaling Factors

(71) Applicant: TRADING TECHNOLOGIES INTERNATIONAL INC., CHICAGO, IL (US)

(72) Inventors: Scott F. SINGER, Green Oaks, IL (US); Charles William CUNNICK, Chicago, IL (US)

(21) Appl. No.: 14/975,448

(22) Filed: Dec. 18, 2015

(51) Int. Cl. G06Q 40/04

(52) U.S. Cl. CPC G06Q 40/04

(57) ABSTRACT

Example methods and systems are described herein that provide a tick size sequence having a plurality of scaling factors or tick sizes that may be used to adjust a tick size of a trading strategy. An example method described herein includes receiving a definition of a trading strategy, which includes two or more legs that correspond to respective tradeable objects offered at an exchange, calculating a first tick size for the trading strategy and determining a tick size sequence to be used when displaying the trading strategy. The tick size sequence has a plurality of scaling factors. The method also includes selecting one of the plurality of scaling factors of the tick size sequence, adjusting the first tick size to a second tick size based on the selected scaling factor and displaying market data associated with the trading strategy in a trading interface according to the second tick size.

### BACKGROUND

An electronic trading system generally includes a trading device in communication with an electronic exchange. The trading device receives information about a market, such as prices and quantities, from the electronic exchange. The electronic exchange receives messages, such as messages related to orders, from the trading device. The electronic exchange attempts to match quantity of an order with quantity of one or more contra-side orders.

Market data related to a tradeable object is often displayed on the trading device via a trading interface or trading application. The trading interface includes a bid column, an ask column and a value column where the current market data may be displayed. The columns are segmented into rows that form cells. Available bid quantities and/or ask quantities are displayed in their respective columns in the cells for a corresponding value of the same row. The value column displays values (e.g., prices) in ascending or descending order. The values increase or decrease at a particular increment known as a tick size. In general, the tick size is set at the smallest change in value for which the respective object can be traded.

### BRIEF DESCRIPTION OF THE FIGURES

Certain embodiments are disclosed with reference to the following drawings.

FIG. 1 illustrates a block diagram representative of an example electronic trading system in which certain embodiments may be employed.

FIG. 2 illustrates a block diagram of another example electronic trading system in which certain embodiments may be employed.

FIG. 3 illustrates a block diagram of an example computing device which may be used to implement the disclosed embodiments.

FIG. 4 illustrates a block diagram of a trading strategy, which may be employed with certain disclosed embodiments.

FIGS. 5A to 5E illustrate block diagrams representative of example trading interfaces in which certain embodiments may be employed.

FIG. 6 illustrates three trading interfaces showing the effects of a known price consolidation technique.

FIG. 7 illustrates an example configuration interface to enable a trader to define a trading strategy and affect a tick size of the trading strategy using an example tick size sequence and scaling factor in accordance with the teachings of this disclosure.

FIG. 8 illustrates three example trading interfaces with tick sizes that have been affected using an example tick size sequence and scaling factor as disclosed herein.

FIG. 9 illustrates a flow diagram of an example method or process to define a trading strategy and determine a tick size sequence and associated scaling factor to affect a tick size of the trading strategy.

FIG. 10 illustrates a block diagram of an example non-linear tick size system that can implement and/or execute the example method of FIG. 9 and which can be used to implement the example configuration interface of FIG. 7 and/or the example trading interface of FIG. 8.

Certain embodiments will be better understood when read in conjunction with the provided figures, which illustrate examples. It should be understood, however, that the embodiments are not limited to the arrangements and instrumentality shown in the attached figures.

### DETAILED DESCRIPTION

This disclosure relates generally to tick sizes in a trading interface and, more particularly, to tools and mechanisms for managing tick size sequences having non-linear scaling factors.

Market data associated with a tradeable object is typically displayed via a trading interface, which may be provided by a trading application or tool on a trading device. The trading interface includes, among other things, a bid column, a value column and an ask column. The columns are sectioned into rows to define cells. Bid quantities and ask quantifies are displayed in the cells adjacent the corresponding values. Values are displayed in the value column based on a set increment or tick size. For example, the tick size may be 1/10^{th} of a cent of a U.S. dollar. Therefore, the values in the value column are displayed at 1/10^{th} of a cent increments (e.g., 0001, 0002, 0003, etc.). The tick size for a tradeable object is based on the smallest value increment at which the tradeable object can be traded. The tick size is dependent on the tradeable object itself.

A trading strategy such as a spreading trading strategy defines a relationship between two or more tradeable objects to be traded. Each tradeable object being traded as part of a trading strategy may be referred to as a leg or outright market of the trading strategy. A trading strategy can involve buying tradeable objects, buying and selling tradeable objects, selling tradeable objects or some combination thereof. The trading strategy may be displayed in a trading interface. In general, the tick size for the spread trading strategy is calculated based on the lowest value increment at which the trading strategy can be bought or sold, which is a function of the individual legs of the trading strategy.

The example systems and methods disclosed herein enable a user to change a tick size or increment for a trading strategy based on a scale or sequence that more appropriately corresponds to the trading strategy. In general, a tick size may be initially calculated for the trading strategy. The calculated tick size is the smallest increment in value in which the trading strategy can be traded, which is typically a relatively small tick size. The example systems and methods determine or select a tick size sequence (e.g., a scale) to be used to modify the calculated tick size to another tick size, which may then be used when displaying market data for the trading strategy. The tick size sequence may be selected from a plurality of available tick size sequences. Each of the tick size sequences has a plurality of scaling factors (e.g., non-linear scaling factors) that can be used to change the tick size of the trading strategy. The new or recalculated tick size is used to display the market data in a trading interface. The scaling factors correspond to tick sizes or increments associated with the respective tick size sequence. A scaling factor may also be referred to as a tick unit, a tick size or tick increment. As a result, the trading strategy may be displayed using a tick size that is easier to understand for the associated trading strategy (e.g., a tick size that is more associated or related with the tradeable object(s) or trading strategy). Additionally, the tick size sequence enables a trader to more easily adjust the tick size to other values that are more natural with respect to the trading strategy and/or preferred by the trader, thereby enabling the trader to make better trading decisions.

Disclosed herein is an example configuration interface (e.g., for use with a trading tool or trading application) that may be used to determine or select a tick size sequence to be used. In some examples, the tick size sequence is determined or selected based on the tick sizes and associated tick size sequences of the legs of the trading strategy. In some examples, a user may select or designate one of the legs of the trading strategy having a representative tick size sequence that should be used. For example, if one of the legs is based on the Euro currency system, then a tick size sequence may be selected that is based on (e.g., matches or corresponds) the Euro currency system. In such an example, the tick size sequence may have a plurality of non-linear scaling factors that correspond to the available denominations of the Euro (e.g., 1 cent of a Euro, 2 cents of a Euro, 5 cents of a Euro, etc.).

In some examples, if all of the tick sizes of the legs of the trading strategy have a same or common sequence, then the tick size sequence is selected as the common sequence of the legs. For example, if a first leg has a tick size of 1 cent based on the U.S. dollar currency system, and a second leg has a tick size of ten cents based on the U.S. dollar currency system, then a tick size sequence may be selected that is based on the U.S. currency system. The tick size sequence may include a plurality of non-linear scaling factors that correspond to the available denominations of the U.S. currency system (e.g., 1 cent (a penny), 5 cents (a nickel), 10 cents (a dime), etc.).

In some examples, if there is only one quoting leg, then a tick size sequence is selected that is based on a tick size sequence of the one quoting leg. For example, if there is only one quoting leg in the trading strategy, and the quoting leg has a tick size of 1 cent based on the U.S. dollar currency system, then a tick size sequence may be selected that is based on the U.S. dollar currency system. In some examples, if there is more than more one quoting leg, and all of the quoting legs have tick sizes associated with a common tick size sequence, then a tick size sequence may be selected that is based on the common tick size sequence of the quoting legs. If all of the quoting legs do not have tick sizes associated with a common tick size sequence, then a tick size sequence may be selected that is based on a tick size sequence of a first one of the quoting legs defined in the trading strategy (e.g., as a default). In some examples, a trader may manually select a tick size sequence (e.g., from a plurality of available tick size sequences).

Once a tick size sequence is determined, a trader can select one of the plurality of available scaling factors from the corresponding tick size sequence. For example, if the selected tick size sequence is based on the U.S. dollar currency system, the scaling factors of the tick size sequence may correspond to the available denominations of U.S. dollar currency system: 1 cent (a penny); 5 cents (a nickel); 10 cents (a dime); 25 cents (a quarter); 50 cents (a half-dollar); one dollar (a dollar bill); 5 dollars (a five dollar bill); 10 dollars (a ten dollar bill); 20 dollars (a twenty dollar bill); 50 dollars (a fifty dollar bill); or 100 dollars (a 100 dollar bill). The trader may adjust (e.g., modify, change, recalculate, etc.) the calculated tick size of the trading strategy based on one of the available denominations using the scaling factors. For example, the trader can select 25 cents ($0.25) as the tick size to display the market data for the trading strategy. As another example, the trader can instead select 5 dollars and, thus, the market data is displayed in 5 dollar increments. As a result, the trader can easily select and/or adjust the tick size for the trading strategy using scaling factors from a tick size sequence that is more related to the trading strategy.

In another example, the tick size for the trading strategy may be calculated to be 1/256 of a dollar based on the U.S. currency system. A tick size sequence may be selected that is based on the U.S. dollar currency system, and the tick size sequenced may include scaling factors that correspond to the available denominations of the U.S. dollar currency system. Therefore, a user can easily switch the tick size in which the market data is to be displayed using the scaling factors of the tick size sequence. For example, the user can select a scaling factor that corresponds to 1 cent ($0.01) and, thus, the calculated tick size may be adjusted or affected to create a modified tick size to be used when displaying the market data.

Although this description discloses embodiments including, among other components, software executed on hardware, it should be noted that the embodiments are merely illustrative and should not be considered as limiting. For example, it is contemplated that any or all of these hardware and software components may be embodied exclusively in hardware, exclusively in software, exclusively in firmware, or in any combination of hardware, software, and/or firmware. Accordingly, certain embodiments may be implemented in other ways.

### I. Brief Description of Certain Embodiments

An embodiment disclosed herein provides a method that includes receiving, via a computing device, a definition of a trading strategy. The definition includes two or more legs that correspond to respective tradeable objects offered at an exchange. The method includes calculating, via a computing device, a first tick size for the trading strategy and determining, via the computing device, a tick size sequence to be used to modify the tick size of the trading strategy. The tick size sequence has a plurality of scaling factors. The method also includes selecting, via the computing device, one of the plurality of scaling factors of the tick size sequence, adjusting, via the computing device, the first tick size to a second tick size based on the selected scaling factor and displaying market data associated with the trading strategy in a trading interface according to the second tick size.

Another embodiment disclosed herein provides a system including computing device configured to receive a definition of a trading strategy. The definition includes two or more legs that correspond to respective tradeable objects offered at an exchange. The computing device is to calculate a first tick size for the trading strategy and determine a tick size sequence to be used to modify the tick size of the trading strategy. The tick size sequence has a plurality of scaling factors. The computing device is also to select one of the plurality of scaling factors of the tick size sequence and adjust the first tick size to a second tick size based on the selected scaling factor. The system also includes a trading interface to display market data associated with the trading strategy according to the second tick size.

Another embodiment disclosed herein provides a tangible computer readable storage device comprising instructions that, when executed, cause a computing device to at least receive a definition of a trading strategy. The definition includes two or more legs that correspond to respective tradeable objects offered at an exchange. The instructions, when executed, cause the machine to calculate a first tick size for the trading strategy and determine a tick size sequence to be used to modify the tick size of the trading strategy. The tick size sequence has a plurality of scaling factors. The instructions, when executed, also cause the machine to select one of the plurality of scaling factors of the tick size sequence, adjust the first tick size to a second tick size based on the selected scaling factor and display market data associated with the trading strategy in a trading interface according to the second tick size.

### II. Example Electronic Trading System

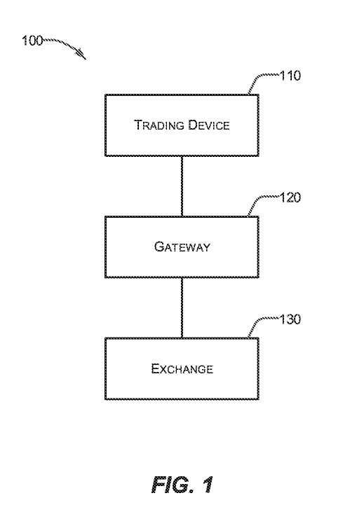

FIG. 1 illustrates a block diagram representative of an example electronic trading system 100 in which certain embodiments may be employed. The system 100 includes a trading device 110, a gateway 120, and an exchange 130. The trading device 110 is in communication with the gateway 120. The gateway 120 is in communication with the exchange 130. As used herein, the phrase “in communication with” encompasses direct communication and/or indirect communication through one or more intermediary components. The exemplary electronic trading system 100 depicted in FIG. 1 may be in communication with additional components, subsystems, and elements to provide additional functionality and capabilities without departing from the teaching and disclosure provided herein.

In operation, the trading device 110 may receive market data from the exchange 130 through the gateway 120. A user may utilize the trading device 110 to monitor this market data and/or base a decision to send an order message to buy or sell one or more tradeable objects to the exchange 130.

Market data may include data about a market for a tradeable object. For example, market data may include the inside market, market depth, last traded price (“LTP”), a last traded quantity (“LTQ”), or a combination thereof. The inside market refers to the highest available bid price (best bid) and the lowest available ask price (best ask or best offer) in the market for the tradeable object at a particular point in time (since the inside market may vary over time). Market depth refers to quantities available at price levels including the inside market and away from the inside market. Market depth may have “gaps” due to prices with no quantity based on orders in the market.

The price levels associated with the inside market and market depth can be provided as value levels which can encompass prices as well as derived and/or calculated representations of value. For example, value levels may be displayed as net change from an opening price. As another example, value levels may be provided as a value calculated from prices in two other markets. In another example, value levels may include consolidated price levels.

A tradeable object is anything which may be traded. For example, a certain quantity of the tradeable object may be bought or sold for a particular price. A tradeable object may include, for example, financial products, stocks, options, bonds, future contracts, currency, warrants, funds derivatives, securities, commodities, swaps, interest rate products, index-based products, traded events, goods, or a combination thereof. A tradeable object may include a product listed and/or administered by an exchange, a product defined by the user, a combination of real or synthetic products, or a combination thereof. There may be a synthetic tradeable object that corresponds and/or is similar to a real tradeable object.

An order message is a message that includes a trade order. A trade order may be, for example, a command to place an order to buy or sell a tradeable object; a command to initiate managing orders according to a defined trading strategy; a command to change, modify, or cancel an order; an instruction to an electronic exchange relating to an order; or a combination thereof.

The trading device 110 may include one or more electronic computing platforms. For example, the trading device 110 may include a desktop computer, hand-held device, laptop, server, a portable computing device, a trading terminal, an embedded trading system, a workstation, an algorithmic trading system such as a “black box” or “grey box” system, cluster of computers, or a combination thereof. As another example, the trading device 110 may include a single or multi-core processor in communication with a memory or other storage medium configured to accessibly store one or more computer programs, applications, libraries, computer readable instructions, and the like, for execution by the processor.

As used herein, the phrases “configured to” and “adapted to” encompass that an element, structure, or device has been modified, arranged, changed, or varied to perform a specific function or for a specific purpose.

By way of example, the trading device 110 may be implemented as a personal computer running a copy of X_TRADER®, an electronic trading platform provided by Trading Technologies International, Inc. of Chicago, Ill. (“Trading Technologies”). As another example, the trading device 110 may be a server running a trading application providing automated trading tools such as ADL®, AUTOSPREADER®, and/or AUTOTRADER™, also provided by Trading Technologies. In yet another example, the trading device 110 may include a trading terminal in communication with a server, where collectively the trading terminal and the server are the trading device 110.

The trading device 110 is generally owned, operated, controlled, programmed, configured, or otherwise used by a user. As used herein, the phrase “user” may include, but is not limited to, a human (for example, a trader), trading group (for example, a group of traders), or an electronic trading device (for example, an algorithmic trading system). One or more users may be involved in the ownership, operation, control, programming, configuration, or other use, for example.

The trading device 110 may include one or more trading applications. As used herein, a trading application is an application that facilitates or improves electronic trading. A trading application provides one or more electronic trading tools. For example, a trading application stored by a trading device may be executed to arrange and display market data in one or more trading windows. In another example, a trading application may include an automated spread trading application providing spread trading tools. In yet another example, a trading application may include an algorithmic trading application that automatically processes an algorithm and performs certain actions, such as placing an order, modifying an existing order, deleting an order. In yet another example, a trading application may provide one or more trading screens. A trading screen may provide one or more trading tools that allow interaction with one or more markets. For example, a trading tool may allow a user to obtain and view market data, set order entry parameters, submit order messages to an exchange, deploy trading algorithms, and/or monitor positions while implementing various trading strategies. The electronic trading tools provided by the trading application may always be available or may be available only in certain configurations or operating modes of the trading application.

A trading application may be implemented utilizing computer readable instructions that are stored in a computer readable medium and executable by a processor. A computer readable medium may include various types of volatile and non-volatile storage media, including, for example, random access memory, read-only memory, programmable read-only memory, electrically programmable read-only memory, electrically erasable read-only memory, flash memory, any combination thereof, or any other tangible data storage device. As used herein, the term non-transitory or tangible computer readable medium is expressly defined to include any type of computer readable storage media and to exclude propagating signals.

One or more components or modules of a trading application may be loaded into the computer readable medium of the trading device 110 from another computer readable medium. For example, the trading application (or updates to the trading application) may be stored by a manufacturer, developer, or publisher on one or more CDs or DVDs, which are then loaded onto the trading device 110 or to a server from which the trading device 110 retrieves the trading application. As another example, the trading device 110 may receive the trading application (or updates to the trading application) from a server, for example, via the Internet or an internal network. The trading device 110 may receive the trading application or updates when requested by the trading device 110 (for example, “pull distribution”) and/or un-requested by the trading device 110 (for example, “push distribution”).

The trading device 110 may be adapted to send order messages. For example, the order messages may be sent to through the gateway 120 to the exchange 130. As another example, the trading device 110 may be adapted to send order messages to a simulated exchange in a simulation environment which does not effectuate real-world trades.

The order messages may be sent at the request of a user. For example, a trader may utilize the trading device 110 to send an order message or manually input one or more parameters for a trade order (for example, an order price and/or quantity). As another example, an automated trading tool provided by a trading application may calculate one or more parameters for a trade order and automatically send the order message. In some instances, an automated trading tool may prepare the order message to be sent but not actually send it without confirmation from a user.

An order message may be sent in one or more data packets or through a shared memory system. For example, an order message may be sent from the trading device 110 to the exchange 130 through the gateway 120. The trading device 110 may communicate with the gateway 120 using a local area network, a wide area network, a wireless network, a virtual private network, a cellular network, a peer-to-peer network, a T1 line, a T3 line, an integrated services digital network (“ISDN”) line, a point-of-presence, the Internet, a shared memory system and/or a proprietary network such as TTNET™ provided by Trading Technologies, for example.

The gateway 120 may include one or more electronic computing platforms. For example, the gateway 120 may be implemented as one or more desktop computer, hand-held device, laptop, server, a portable computing device, a trading terminal, an embedded trading system, workstation with a single or multi-core processor, an algorithmic trading system such as a “black box” or “grey box” system, cluster of computers, or any combination thereof.

The gateway 120 may facilitate communication. For example, the gateway 120 may perform protocol translation for data communicated between the trading device 110 and the exchange 130. The gateway 120 may process an order message received from the trading device 110 into a data format understood by the exchange 130, for example. Similarly, the gateway 120 may transform market data in an exchange-specific format received from the exchange 130 into a format understood by the trading device 110, for example.

The gateway 120 may include a trading application, similar to the trading applications discussed above, that facilitates or improves electronic trading. For example, the gateway 120 may include a trading application that tracks orders from the trading device 110 and updates the status of the order based on fill confirmations received from the exchange 130. As another example, the gateway 120 may include a trading application that coalesces market data from the exchange 130 and provides it to the trading device 110. In yet another example, the gateway 120 may include a trading application that provides risk processing, calculates implieds, handles order processing, handles market data processing, or a combination thereof.

In certain embodiments, the gateway 120 communicates with the exchange 130 using a local area network, a wide area network, a wireless network, a virtual private network, a cellular network, a peer-to-peer network, a T1 line, a T3 line, an ISDN line, a point-of-presence, the Internet, a shared memory system, and/or a proprietary network such as TTNET™ provided by Trading Technologies, for example.

The exchange 130 may be owned, operated, controlled, or used by an exchange entity. Example exchange entities include the CME Group, the London International Financial Futures and Options Exchange, the Intercontinental Exchange, and Eurex. The exchange 130 may include an electronic matching system, such as a computer, server, or other computing device, which is adapted to allow tradeable objects, for example, offered for trading by the exchange, to be bought and sold. The exchange 130 may include separate entities, some of which list and/or administer tradeable objects and others which receive and match orders, for example. The exchange 130 may include an electronic communication network (“ECN”), for example.

The exchange 130 may be an electronic exchange. The exchange 130 is adapted to receive order messages and match contra-side trade orders to buy and sell tradeable objects. Unmatched trade orders may be listed for trading by the exchange 130. Once an order to buy or sell a tradeable object is received and confirmed by the exchange, the order is considered to be a working order until it is filled or cancelled. If only a portion of the quantity of the order is matched, then the partially filled order remains a working order. The trade orders may include trade orders received from the trading device 110 or other devices in communication with the exchange 130, for example. For example, typically the exchange 130 will be in communication with a variety of other trading devices (which may be similar to trading device 110) which also provide trade orders to be matched.

The exchange 130 is adapted to provide market data. Market data may be provided in one or more messages or data packets or through a shared memory system. For example, the exchange 130 may publish a data feed to subscribing devices, such as the trading device 110 or gateway 120. The data feed may include market data.

The system 100 may include additional, different, or fewer components. For example, the system 100 may include multiple trading devices, gateways, and/or exchanges. In another example, the system 100 may include other communication devices, such as middleware, firewalls, hubs, switches, routers, servers, exchange-specific communication equipment, modems, security managers, and/or encryption/decryption devices.

### III. Expanded Example Electronic Trading System

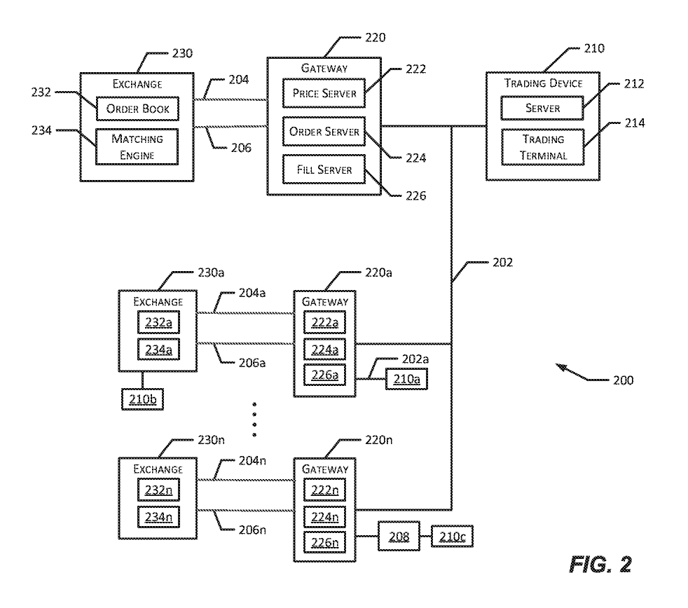

FIG. 2 illustrates a block diagram of another example electronic trading system 200 in which certain embodiments may be employed. In this example, a trading device 210 may utilize one or more communication networks to communicate with a gateway 220 and exchange 230. For example, the trading device 210 utilizes network 202 to communicate with the gateway 220, and the gateway 220, in turn, utilizes the networks 204 and 206 to communicate with the exchange 230. As used herein, a network facilitates or enables communication between computing devices such as the trading device 210, the gateway 220, and the exchange 230.

The following discussion generally focuses on the trading device 210, gateway 220, and the exchange 230. However, the trading device 210 may also be connected to and communicate with “n” additional gateways (individually identified as gateways 220a-220n, which may be similar to gateway 220) and “n” additional exchanges (individually identified as exchanges 230a-230n, which may be similar to exchange 230) by way of the network 202 (or other similar networks). Additional networks (individually identified as networks 204a-204n and 206a-206n, which may be similar to networks 204 and 206, respectively) may be utilized for communications between the additional gateways and exchanges. The communication between the trading device 210 and each of the additional exchanges 230a-230n need not be the same as the communication between the trading device 210 and exchange 230. Generally, each exchange has its own preferred techniques and/or formats for communicating with a trading device, a gateway, the user, or another exchange. It should be understood that there is not necessarily a one-to-one mapping between gateways 220a-220n and exchanges 230a-230n. For example, a particular gateway may be in communication with more than one exchange. As another example, more than one gateway may be in communication with the same exchange. Such an arrangement may, for example, allow one or more trading devices 210 to trade at more than one exchange (and/or provide redundant connections to multiple exchanges).

Additional trading devices 210a-210n, which may be similar to trading device 210, may be connected to one or more of the gateways 220a-220n and exchanges 230a-230n. For example, the trading device 210a may communicate with the exchange 230a via the gateway 220a and the networks 202a, 204a and 206a. In another example, the trading device 210b may be in direct communication with exchange 230a. In another example, trading device 210c may be in communication with the gateway 220n via an intermediate device 208 such as a proxy, remote host, or WAN router.

The trading device 210, which may be similar to the trading device 110 in FIG. 1, includes a server 212 in communication with a trading terminal 214. The server 212 may be located geographically closer to the gateway 220 than the trading terminal 214 in order to reduce latency. In operation, the trading terminal 214 may provide a trading screen to a user and communicate commands to the server 212 for further processing. For example, a trading algorithm may be deployed to the server 212 for execution based on market data. The server 212 may execute the trading algorithm without further input from the user. In another example, the server 212 may include a trading application providing automated trading tools and communicate back to the trading terminal 214. The trading device 210 may include additional, different, or fewer components.

In operation, the network 202 may be a multicast network configured to allow the trading device 210 to communicate with the gateway 220. Data on the network 202 may be logically separated by subject such as, for example, by prices, orders, or fills. As a result, the server 212 and trading terminal 214 can subscribe to and receive data such as, for example, data relating to prices, orders, or fills, depending on their individual needs.

The gateway 220, which may be similar to the gateway 120 of FIG. 1, may include a price server 222, order server 224, and fill server 226. The gateway 220 may include additional, different, or fewer components. The price server 222 may process price data. Price data includes data related to a market for one or more tradeable objects. The order server 224 processes order data. Order data is data related to a user's trade orders. For example, order data may include order messages, confirmation messages, or other types of messages. The fill server collects and provides fill data. Fill data includes data relating to one or more fills of trade orders. For example, the fill server 226 may provide a record of trade orders, which have been routed through the order server 224, that have and have not been filled. The servers 222, 224, and 226 may run on the same machine or separate machines. There may be more than one instance of the price server 222, the order server 224, and/or the fill server 226 for gateway 220. In certain embodiments, the additional gateways 220a-220n may each includes instances of the servers 222, 224, and 226 (individually identified as servers 222a-222n, 224a-224n, and 226a-226n).

The gateway 220 may communicate with the exchange 230 using one or more communication networks. For example, as shown in FIG. 2, there may be two communication networks connecting the gateway 220 and the exchange 230. The network 204 may be used to communicate market data to the price server 222. In some instances, the exchange 230 may include this data in a data feed that is published to subscribing devices. The network 206 may be used to communicate order data to the order server 224 and the fill server 226. The network 206 may also be used to communicate order data from the order server 224 to the exchange 230.

The exchange 230, which may be similar to the exchange 130 of FIG. 1, includes an order book 232 and a matching engine 234. The exchange 230 may include additional, different, or fewer components. The order book 232 is a database that includes data relating to unmatched trade orders that have been submitted to the exchange 230. For example, the order book 232 may include data relating to a market for a tradeable object, such as the inside market, market depth at various price levels, the last traded price, and the last traded quantity. The matching engine 234 may match contra-side bids and offers pending in the order book 232. For example, the matching engine 234 may execute one or more matching algorithms that match contra-side bids and offers. A sell order is contra-side to a buy order. Similarly, a buy order is contra-side to a sell order. A matching algorithm may match contra-side bids and offers at the same price, for example. In certain embodiments, the additional exchanges 230a-230n may each include order books and matching engines (individually identified as the order book 232a-232n and the matching engine 234a-234n, which may be similar to the order book 232 and the matching engine 234, respectively). Different exchanges may use different data structures and algorithms for tracking data related to orders and matching orders.

In operation, the exchange 230 may provide price data from the order book 232 to the price server 222 and order data and/or fill data from the matching engine 234 to the order server 224 and/or the fill server 226. Servers 222, 224, 226 may process and communicate this data to the trading device 210. The trading device 210, for example, using a trading application, may process this data. For example, the data may be displayed to a user. In another example, the data may be utilized in a trading algorithm to determine whether a trade order should be submitted to the exchange 230. The trading device 210 may prepare and send an order message to the exchange 230.

In certain embodiments, the gateway 220 is part of the trading device 210. For example, the components of the gateway 220 may be part of the same computing platform as the trading device 210. As another example, the functionality of the gateway 220 may be performed by components of the trading device 210. In certain embodiments, the gateway 220 is not present. Such an arrangement may occur when the trading device 210 does not need to utilize the gateway 220 to communicate with the exchange 230, such as if the trading device 210 has been adapted to communicate directly with the exchange 230.

### IV. Example Computing Device

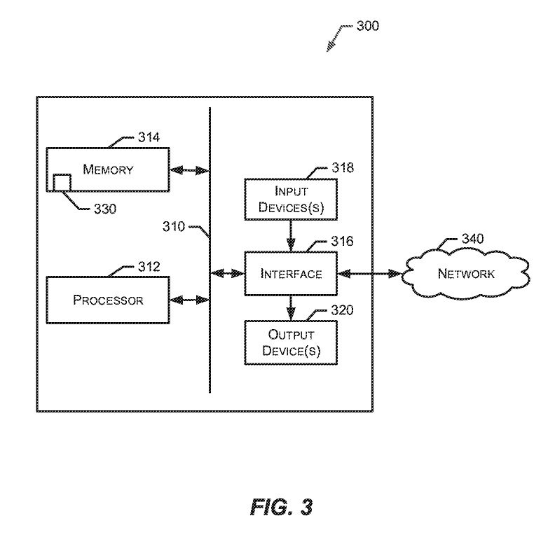

FIG. 3 illustrates a block diagram of an example computing device 300 which may be used to implement the disclosed embodiments. The trading device 110 of FIG. 1 may include one or more computing devices 300, for example. The gateway 120 of FIG. 1 may include one or more computing devices 300, for example. The exchange 130 of FIG. 1 may include one or more computing devices 300, for example.

The computing device 300 includes a communication network 310, a processor 312, a memory 314, an interface 316, an input device 318, and an output device 320. The computing device 300 may include additional, different, or fewer components. For example, multiple communication networks, multiple processors, multiple memory, multiple interfaces, multiple input devices, multiple output devices, or any combination thereof, may be provided. As another example, the computing device 300 may not include an input device 318 or output device 320.

As shown in FIG. 3, the computing device 300 may include a processor 312 coupled to a communication network 310. The communication network 310 may include a communication bus, channel, electrical or optical network, circuit, switch, fabric, or other mechanism for communicating data between components in the computing device 300. The communication network 310 may be communicatively coupled with and transfer data between any of the components of the computing device 300.

The processor 312 may be any suitable processor, processing unit, or microprocessor. The processor 312 may include one or more general processors, digital signal processors, application specific integrated circuits, field programmable gate arrays, analog circuits, digital circuits, programmed processors, and/or combinations thereof, for example. The processor 312 may be a single device or a combination of devices, such as one or more devices associated with a network or distributed processing. Any processing strategy may be used, such as multi-processing, multi-tasking, parallel processing, and/or remote processing. Processing may be local or remote and may be moved from one processor to another processor. In certain embodiments, the computing device 300 is a multi-processor system and, thus, may include one or more additional processors which are communicatively coupled to the communication network 310.

The processor 312 may be operable to execute logic and other computer readable instructions encoded in one or more tangible media, such as the memory 314. As used herein, logic encoded in one or more tangible media includes instructions which may be executable by the processor 312 or a different processor. The logic may be stored as part of software, hardware, integrated circuits, firmware, and/or micro-code, for example. The logic may be received from an external communication device via a communication network such as the network 340. The processor 312 may execute the logic to perform the functions, acts, or tasks illustrated in the figures or described herein.

The memory 314 may be one or more tangible media, such as computer readable storage media, for example. Computer readable storage media may include various types of volatile and non-volatile storage media, including, for example, random access memory, read-only memory, programmable read-only memory, electrically programmable read-only memory, electrically erasable read-only memory, flash memory, any combination thereof, or any other tangible data storage device. As used herein, the term non-transitory or tangible computer readable medium is expressly defined to include any type of computer readable medium and to exclude propagating signals. The memory 314 may include any desired type of mass storage device including hard disk drives, optical media, magnetic tape or disk, etc.

The memory 314 may include one or more memory devices. For example, the memory 314 may include local memory, a mass storage device, volatile memory, non-volatile memory, or a combination thereof. The memory 314 may be adjacent to, part of, programmed with, networked with, and/or remote from processor 312, so the data stored in the memory 314 may be retrieved and processed by the processor 312, for example. The memory 314 may store instructions which are executable by the processor 312. The instructions may be executed to perform one or more of the acts or functions described herein or shown in the figures.

The memory 314 may store a trading application 330. In certain embodiments, the trading application 330 may be accessed from or stored in different locations. The processor 312 may access the trading application 330 stored in the memory 314 and execute computer-readable instructions included in the trading application 330.

In certain embodiments, during an installation process, the trading application may be transferred from the input device 318 and/or the network 340 to the memory 314. When the computing device 300 is running or preparing to run the trading application 330, the processor 312 may retrieve the instructions from the memory 314 via the communication network 310.

### V. Strategy Trading

In addition to buying and/or selling a single tradeable object, a user may trade more than one tradeable object according to a trading strategy. One common trading strategy is a spread and trading according to a trading strategy may also be referred to as spread trading. Spread trading may attempt to capitalize on changes or movements in the relationships between the tradeable object in the trading strategy, for example.

An automated trading tool may be utilized to trade according to a trading strategy, for example. For example, the automated trading tool may include AUTOSPREADER®, provided by Trading Technologies.

A trading strategy defines a relationship between two or more tradeable objects to be traded. Each tradeable object being traded as part of a trading strategy may be referred to as a leg or outright market of the trading strategy.

When the trading strategy is to be bought, the definition for the trading strategy specifies which tradeable object corresponding to each leg should be bought or sold. Similarly, when the trading strategy is to be sold, the definition specifies which tradeable objects corresponding to each leg should be bought or sold. For example, a trading strategy may be defined such that buying the trading strategy involves buying one unit of a first tradeable object for leg A and selling one unit of a second tradeable object for leg B. Selling the trading strategy typically involves performing the opposite actions for each leg.

In addition, the definition for the trading strategy may specify a spread ratio associated with each leg of the trading strategy. The spread ratio may also be referred to as an order size for the leg. The spread ratio indicates the quantity of each leg in relation to the other legs. For example, a trading strategy may be defined such that buying the trading strategy involves buying 2 units of a first tradeable object for leg A and selling 3 units of a second tradeable object for leg B. The sign of the spread ratio may be used to indicate whether the leg is to be bought (the spread ratio is positive) or sold (the spread ratio is negative) when buying the trading strategy. In the example above, the spread ratio associated with leg A would be “2” and the spread ratio associated with leg B would be “−3.”

In some instances, the spread ratio may be implied or implicit. For example, the spread ratio for a leg of a trading strategy may not be explicitly specified, but rather implied or defaulted to be “1” or “−1.”

In addition, the spread ratio for each leg may be collectively referred to as the spread ratio or strategy ratio for the trading strategy. For example, if leg A has a spread ratio of “2” and leg B has a spread ratio of “−3”, the spread ratio (or strategy ratio) for the trading strategy may be expressed as “2:−3” or as “2:3” if the sign for leg B is implicit or specified elsewhere in a trading strategy definition.

Additionally, the definition for the trading strategy may specify a multiplier associated with each leg of the trading strategy. The multiplier is used to adjust the price of the particular leg for determining the price of the spread. The multiplier for each leg may be the same as the spread ratio. For example, in the example above, the multiplier associated with leg A may be “2” and the multiplier associated with leg B may be “−3,” both of which match the corresponding spread ratio for each leg. Alternatively, the multiplier associated with one or more legs may be different than the corresponding spread ratios for those legs. For example, the values for the multipliers may be selected to convert the prices for the legs into a common currency.

The following discussion assumes that the spread ratio and multipliers for each leg are the same, unless otherwise indicated. In addition, the following discussion assumes that the signs for the spread ratio and the multipliers for a particular leg are the same and, if not, the sign for the multiplier is used to determine which side of the trading strategy a particular leg is on.

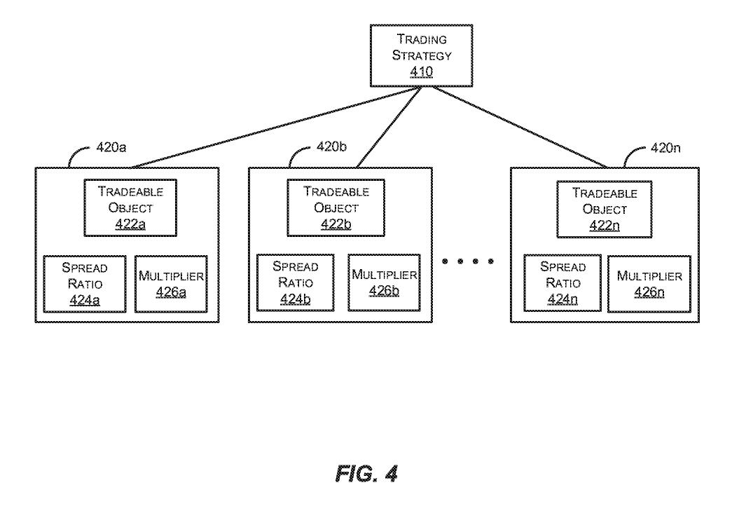

FIG. 4 illustrates a block diagram of a trading strategy 410 which may be employed with certain disclosed embodiments. The trading strategy 410 includes “n” legs 420 (individually identified as leg 420a to leg 420n). The trading strategy 410 defines the relationship between tradeable objects 422 (individually identified as tradeable object 422a to tradeable object 422n) of each of the legs 420a to 420n using the corresponding spread ratios 424a to 424n and multipliers 426a to 426n.

Once defined, the tradeable objects 422 in the trading strategy 410 may then be traded together according to the defined relationship. For example, assume that the trading strategy 410 is a spread with two legs, leg 420a and leg 420b. Leg 420a is for tradeable object 422a and leg 420b is for tradeable object 422b. In addition, assume that the spread ratio 424a and multiplier 426a associated with leg 420a are “1” and that the spread ratio 424b and multiplier 426b associated with leg 420b are “−1”. That is, the spread is defined such that when the spread is bought, 1 unit of tradeable object 422a is bought (positive spread ratio, same direction as the spread) and 1 unit of tradeable object 422b is sold (negative spread ratio, opposite direction of the spread). As mentioned above, typically in spread trading the opposite of the definition applies. That is, when the definition for the spread is such that when the spread is sold, 1 unit of tradeable object 422a is sold (positive spread ratio, same direction as the spread) and 1 unit of tradeable object 422b is bought (negative spread ratio, opposite direction of the spread).

The price for the trading strategy 410 is determined based on the definition. In particular, the price for the trading strategy 410 is typically the sum of price the legs 420a-420n comprising the tradeable objects 422a-422n multiplied by corresponding multipliers 426a-426n. The price for a trading strategy may be affected by price tick rounding and/or pay-up ticks. However, both of these implementation details are beyond the scope of this discussion and are well-known in the art.

Recall that, as discussed above, a real spread may be listed at an exchange, such as exchange 130 and/or 230, as a tradeable product. In contrast, a synthetic spread may not be listed as a product at an exchange, but rather the various legs of the spread are tradeable at one or more exchanges. For the purposes of the following example, the trading strategy 410 described is a synthetic trading strategy. However, similar techniques to those described below may also be applied by an exchange when a real trading strategy is traded.

Continuing the example from above, if it is expected or believed that tradeable object 422a typically has a price 10 greater than tradeable object 422b, then it may be advantageous to buy the spread whenever the difference in price between tradeable objects 422a and 422b is less than 10 and sell the spread whenever the difference is greater than 10. As an example, assume that tradeable object 422a is at a price of 45 and tradeable object 422b is at a price of 40. The current spread price may then be determined to be (1)(45)+(−1)(40)=5, which is less than the typical spread of 10. Thus, a user may buy 1 unit of the spread, which results in buying 1 unit of tradeable object 422a at a price of 45 and selling 1 unit of tradeable object 422b at 40. At some later time, the typical price difference may be restored and the price of tradeable object 422a is 42 and the price of tradeable object 422b is 32. At this point, the price of the spread is now 10. If the user sells 1 unit of the spread to close out the user's position (that is, sells 1 unit of tradeable object 422a and buys 1 unit of tradeable object 422b), the user has made a profit on the total transaction. In particular, while the user bought tradeable object 422a at a price of 45 and sold at 42, losing 3, the user sold tradeable object 422b at a price of 40 and bought at 32, for a profit of 8. Thus, the user made 5 on the buying and selling of the spread.

The above example assumes that there is sufficient liquidity and stability that the tradeable objects can be bought and sold at the market price at approximately the desired times. This allows the desired price for the spread to be achieved. However, more generally, a desired price at which to buy or sell a particular trading strategy is determined. Then, an automated trading tool, for example, attempts to achieve that desired price by buying and selling the legs at appropriate prices. For example, when a user instructs the trading tool to buy or sell the trading strategy 410 at a desired price, the automated trading tool may automatically place an order (also referred to as quoting an order) for one of the tradeable objects 422 of the trading strategy 410 to achieve the desired price for the trading strategy (also referred to as a desired strategy price, desired spread price, and/or a target price). The leg for which the order is placed is referred to as the quoting leg. The other leg is referred to as a lean leg and/or a hedge leg. The price that the quoting leg is quoted at is based on a target price that an order could be filled at in the lean leg. The target price in the hedge leg is also known as the leaned on price, lean price, and/or lean level. Typically, if there is sufficient quantity available, the target price may be the best bid price when selling and the best ask price when buying. The target price may be different than the best price available if there is not enough quantity available at that price or because it is an implied price, for example. As the leaned on price changes, the price for the order in the quoting leg may also change to maintain the desired strategy price.

The leaned on price may also be determined based on a lean multiplier and/or a lean base. A lean multiplier may specify a multiple of the order quantity for the hedge leg that should be available to lean on that price level. For example, if a quantity of 10 is needed in the hedge leg and the lean multiplier is 2, then the lean level may be determined to be the best price that has at least a quantity of 20 available. A lean base may specify an additional quantity above the needed quantity for the hedge leg that should be available to lean on that price level. For example, if a quantity of 10 is needed in the hedge leg and the lean base is 5, then the lean level may be determined to be the best price that has at least a quantity of 15 available. The lean multiplier and lean base may also be used in combination. For example, the lean base and lean multiplier may be utilized such that larger of the two is used or they may be used additively to determine the amount of quantity to be available.

When the quoting leg is filled, the automated trading tool may then submit an order in the hedge leg to complete the strategy. This order may be referred to as an offsetting or hedging order. The offsetting order may be placed at the leaned on price or based on the fill price for the quoting order, for example. If the offsetting order is not filled (or filled sufficiently to achieve the desired strategy price), then the strategy order is said to be “legged up” or “legged” because the desired strategy relationship has not been achieved according to the trading strategy definition.

In addition to having a single quoting leg, as discussed above, a trading strategy may be quoted in multiple (or even all) legs. In such situations, each quoted leg still leans on the other legs. When one of the quoted legs is filled, typically the orders in the other quoted legs are cancelled and then appropriate hedge orders are placed based on the lean prices that the now-filled quoting leg utilized.

### VI. Trading Interface

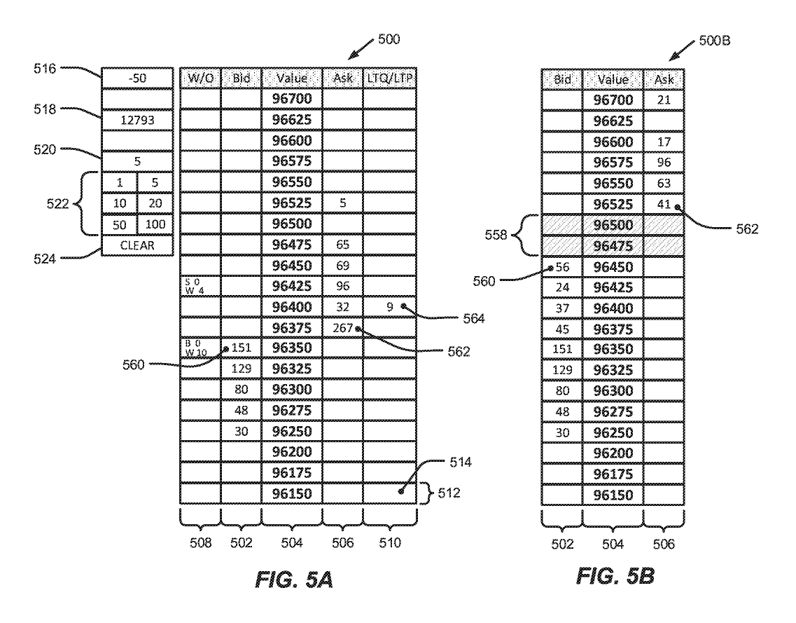

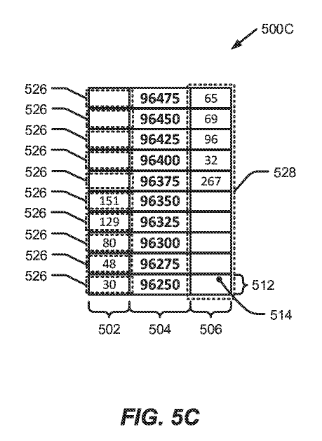

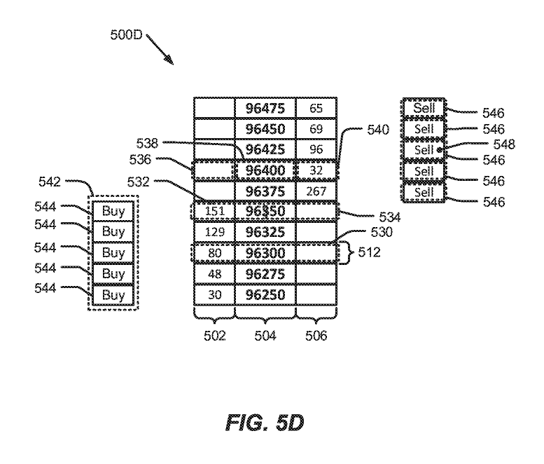

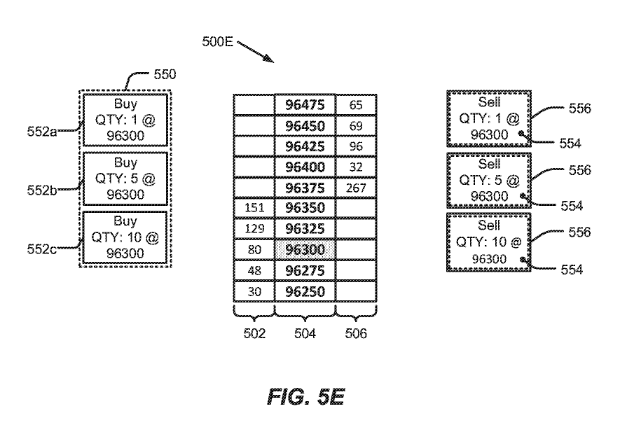

FIG. 5A illustrates an example trading interface 500 in which certain embodiments may be employed. The example trading interface 500 shows market data for a tradeable object (e.g., a trading strategy) at a first point in time. While the following examples are described in conjunction with the example electronic trading system 200 of FIG. 2, the examples disclosed herein may be implemented in other electronic trading systems, such as the example trading system 100 of FIG. 1.

As described above in conjunction with FIG. 2, the trading device 210 receives market data related to one or more tradeable objects from the exchange 230 and/or the exchanges 230a-230n through the gateway 220 and/or the gateways 220a-220n, respectively. The trading device 210 provides a trading application including trading tools to process and/or organize the market data and provide the example trading interface 500. Trading tools include, for example, MD TRADER®, X_TRADER®, ADL®, AUTOSPREADER®, and AUTOTRADER™, each provided by Trading Technologies. The trading device 210 provides the trading interface 500 to enable a user to view market data and communicate trade orders and trade actions with an electronic exchange.

In the illustrated example of FIG. 5A, the trading interface 500 includes a bid column 502, a value column 504, and an ask column 506. The trading interface 500 further includes a working order (W/O) column 508 and a last traded quantity (LTQ)/last traded price (LTP) column 510. The trading interface 500 may include other columns such as an estimated position in queue (EPIQ) column, a single combined bid/ask column, a user-defined indicator column, an inside market indicator column, and/or any other column for providing indicators. The trading interface 500 also includes rows such as row 512. The columns intersect with the rows to define cells such as cell 514. In other embodiments, different orientations other than vertical columns may be used (e.g., horizontal and diagonal arrangements).

In the illustrated example, bid indicators representing the bid quantities of the tradeable object are displayed in the bid column 502, value indicators corresponding to value levels are displayed in the value column 504, and ask indicators representing the ask quantities of the tradeable object are displayed in the ask column 506. A bid quantity is a quantity available on the bid side of the tradeable object at a given value level. The value levels can be configured to represent prices, net change, derivatives of price, consolidated prices, synthetic tradeable object pricing, spread pricing, and/or other representations of value. The values can be displayed as increasing or decreasing based on a calculated tick size (e.g., an increment). The tick size is typically the smallest increment or change in value in which the object can be traded. A tick size for a trading strategy, for example, may be calculated based the legs of the trading strategy, which affect the smallest change in value in which the trading strategy can be traded. The ask quantity is a quantity available on the ask side of the tradeable object at a given value level. The indicators are not limited to numerical values and can include any type or combination of indicator or symbol to illustrate the available quantity without providing a specific numeric value. For example, the indicators may include text, icons, colors, lines, and/or other graphical representations. In one example, the indicators may represent a range of quantity available at particular value levels in place of specific, and frequently changing, quantity values. In another example, the relative size of indicators may proportionally represent the quantity available.

Trading interfaces, such as the trading interface 500, may include indicators to identify the inside market. Examples of inside market indicators include a best bid price indicator representing the highest available bid price, a best ask price indicator representing the lowest available ask price, and/or an indicator representing a range between the highest available bid price and the lowest available ask price. As shown in FIG. 5B, the inside market indicator may highlight and identify the range 558 of value levels between the highest available bid price of “96450” and the lowest available ask price of “96525”. Inside market indicators may be displayed within the trading interface to identify specific value level(s) in the value column 504. For example, a best bid price indicator may be displayed in a cell containing a bid quantity indicator and corresponding to a value level that reflects the best bid price. As another example, a best ask price indicator may be a color or symbol combined with an ask quantity indicator in the ask column 506 in a cell corresponding to a value level that reflects the best ask price. As another example, inside market indicators may be displayed at value levels within the value column 504 that reflect the best bid price and the best ask price. The inside market indicators can include any type or combination of indicator or symbol (e.g., the indicators may include text, icons, colors, lines, and/or other graphical representations).

In certain embodiments, the inside market indicators may be provided by the presence of a quantity indicator. For example, the presence of the best bid quantity indicator, independent of the quantity value displayed at any given point in time, in the bid column may be, in effect, the best bid price indicator. Thus, the existence of a quantity indicator at the highest value level in the bid column is the best bid price indicator. To be clear, the value of the bid quantity indicator is not part of the best bid price indicator in this example. Rather, the existence of the bid quantity itself as the highest one in the column is the best bid price indicator. As shown in FIG. 5A, the presence of the bid quantity indicator “151” at the highest value level in the bid column at the price of “96350” is the best bid price indicator 560. Similarly, the presence of the ask quantity indicator “267” at the lowest value level in the ask column at the price of “96375” is the best ask price indicator 562.

From the user's perspective, the trading interface 500 may present and display indicators, such as inside market and LTP/LTQ indicators, in a manner that conveys the appearance of movement relative to the value column 504. For example, the manner in which the trading interface alters the position of the best bid price indicator and the best ask price indicator relative to the value levels within the value column may allow the user to perceive changes in both the speed and direction of trading within a market. The trading interface 500 updates based on received market data. For example, the trading interface 500 moves the best bid price indicator 560 relative to the value column 504 when the received market data includes a quantity at a new highest bid price. As another example, the trading interface 500 moves a LTP indicator 564 (shown in the LTQ column 510 of FIG. 5A) relative to the value column 504 when the received market data includes a new last traded price.

The trading interface 500 shown in FIG. 5A depicts and identifies the inside market via the best bid price indicator 560 aligned with the highest available bid price and the best ask price indicator 562 aligned with the lowest available ask price at a first point in time. For example, the best bid price indicator 560 is moved to reflect the change in the best bid price from “96350” (FIG. 5A) to “96450” (FIG. 5B). Similarly, the best ask price indicator 562 is moved to reflect the change in the best ask price from “96375” to “96525”. By observing the movement of the inside market indicators relative to the value column 504 in the described manner, the user can quickly perceive that the market is trading higher.

Moreover, as illustrated in the trading interface 500 shown in FIG. 5A, the bid quantity indicator “151” is at the best bid price “96350” and the ask quantity indicator “267” is at the best ask price “96375”. At the second point in time, the displayed quantity indicators are updated to reflect new quantities available. As shown in FIG. 5B, the bid quantity indicator “56” is at the best bid price “96450” and the ask quantity indicator “41” is at the best ask price “96525”. Although the quantity values have changed, it is the presence of the bid quantity indicator at the highest value level in the bid column and the presence of the ask quantity indicator at the lowest value level that are the inside market indicators.

The movement of the indicators relative to the value column 504 may be implemented in a variety of ways. In one example, movement of an indicator includes repositioning the indicator from one location to another location. In another example, movement of an indicator includes removing the indicator at one location and replacing it with a new indicator at another location, which as user may perceive as the appearance of movement.

When quantity information is displayed in relation to the value column 504 and the market moves up or down, the inside market indicators can be said to “move” up or down from the user's perspective in relation to the value column 504 to reflect a new highest bid price or a new lowest ask price. For example, when the quantity indicators are represented with numerical values and the inside market indicators are provided by the presence of the highest bid quantity indicator and lowest ask quantity indicator, the exact numeric value representing the quantity at the best bid price or the best ask price need not move or provide the appearance of movement. The quantity indicators, in this particular example, at those particular price levels may have changed, but they do not actually move—it is the best bid indicator that has “moved.”

The value indicators in the value column 504 may be repositioned. A selected value indicator may be repositioned to a designated location and other value indicators are repositioned relative to the selected value indicator. The selected value indicator may be based on, for example, a user selection or market related values such as the highest bid price or lowest ask price, LTP, and a calculated average of the best bid and best ask prices. The designated location may be a pre-determined location or a location defined by a user. In one configuration, in response to the repositioning command, the selected value indicator may be moved to the designated location corresponding to the middle of the display (e.g., to a location corresponding substantially to the midpoint of the length of the value column 504). In another configuration, in response to the repositioning command, the selected value indicator can be displayed at a user-identified or pre-defined position within the display.

The value indicators in the value column 504 may be repositioned in response to various commands or triggering conditions. In one example, the value indicators displayed in the value column 504 may be repositioned in response to a manual repositioning command. In another example, the value indicators displayed in the value column 504 may be repositioned automatically in response to an automatic repositioning command. The automatic repositioning command may, for example, be received upon detection of a triggering condition. Some examples of a triggering condition include: expiration of an alarm or timer; a determination that the inside market is, or may be, moving off the display; a determination that the inside market has exceeded an upper threshold or a lower threshold; an event in another trading interface; a market event relating to the same or a different tradeable object; a user-defined event; and/or a determination that a value exceeds a threshold.

In some examples, an indicator based on market data (such as best bid, best ask, LTP) may be displayed at the same fixed location in the trading interface 500. For example, the best bid indicator in the bid column 502 may be displayed at a specified fixed location. The fixed location may be pre-determined or defined by a user. For example, the best bid indicator and/or the best ask indicator may, for example, be maintained at the center of the display, at the top of the display, at the bottom of the display or any designated location.

In the illustrated example, the values, which are prices, are displayed without decimal points (which may be a format or convention expected by a user) and in descending order from a top to a bottom of the value column 504 in the orientation of FIG. 5A. In other examples, the prices are listed in other orders (e.g., ascending order from top to bottom) and/or formats (e.g., with decimal points, fractions, in scientific notation, and/or any other format).

In the illustrated example, the indicators in the bid column 502 and the ask column 506 are updated to indicate quantity changes at each value level identified along the value column 504. For example, values of the ask quantities and/or the bid quantities may increase or decrease due to order quantities being added, deleted or matched at each value level. The indicators may be updated based on a timer and/or in response to new data being received, for example.

In some examples, the trading interface 500 includes additional and/or different information. In the illustrated example, the trading interface 500 also displays a net price change 516 of the tradeable object over a given amount of time (e.g., since the market opened on a given day). The trading interface 500 also includes a total volume 518 of the tradeable object (e.g., a number of lots that have been traded). Other embodiments may include different and/or additional information.

The trading interface 500 also enables the user to specify parameters for a trade order. In the illustrated example, the trading interface 500 includes a quantity field 520. The quantity field 520 displays a quantity (e.g., 5) for an order that the user will send to market, and the user may adjust the quantity by selecting (e.g., via a mouse) one of a plurality of buttons 522 adjacent the quantity field 520 or entering a new value into the quantity field 520. If the user selects a button 524 labeled “CLEAR” in the illustrated example, the quantity field 520 is cleared (e.g., the quantity displayed in the quantity field 520 is adjusted to be zero).

The trading interface 500 further enables the user to enter an order to buy or sell a tradeable object via an order entry area configured to receive a selection and in response initiate placement of the order. Selection of an order area may be by a single action of an input device such as a single click, a double click, or a multi-touch gesture. Initiating placement of an order may include preparing a message to send an order to an exchange or sending an order to an electronic exchange. The trading interface 500 may include multiple order entry areas. The trading interface 500 may request that a user confirm an order to be placed prior to sending it.

Order entry areas may overlap or encompass one or more regions of a trading interface. For example, an order entry area may overlap all or part of the cells making up a row. As another example, an order entry area may overlap all or part of the cells in a column such as the bid column, ask column or value column. In another example, an order entry area may overlap a cell and a region outside of the cell. In certain embodiments, a trading interface may include a first order entry area overlapping first cell and a second order entry area overlapping a second cell. In certain embodiments, a first order entry area overlaps a first cell and a portion of a second cell, and a second order entry area overlaps a portion of the second cell and a third cell. In certain embodiments, order entry areas may encompass other regions of the trading interface.

Each order entry area may align with a value level. For example, an order entry area may be aligned with one of the value levels making up the value column 504. In another example, an order entry area may be independent of and not aligned with a value level.

An order entry area may be linked to other elements of the trading interface 500. For example, an order entry area may be linked to a particular value level making up a value column by specifying a value level followed by specifying an order entry area. Subsequently, selection of the linked order entry initiates placement of the order based on the linked value. As another example, selection of a cell associated with a particular value level may link a pre-defined order entry area to the particular value level.

Upon selection of an order entry area to initiate placement of an order, one or more parameters of the order may be determined based on the selected order entry area. Order parameters may include order price, order quantity, order side, and/or order type. Other order parameters may be specified. Values for the parameters may be default values, preconfigured values, values set based on the location of the selection within the order entry area, values set based on the location of the order entry area, values set based on the method of the selection (e.g., a left click, a right click, a keyboard entry and a double click).

The manner in which the selection of an order entry area is made may affect the type of order or the way in which placement of an order is initiated. For example, selection within a row configured as an order entry area may include correlating the position of the selection to a specific cell or column arranged and aligned relative to the order entry area. The type of single action provided via the input device may further specify the selection. For example, if the user initiates a single action corresponding to a right click within an order entry area aligned with a portion of the row corresponding to a cell in the value column, then the selection may initiate placement of a buy order. Similarly, if the user initiates a single action corresponding to a left click over a portion of the row corresponding to a cell in the value column, then the selection may initiate placement of a sell order. As another example, selecting an order entry area encompassing the cells in the bid column may initiate placement of a buy market order when the selection is a single point touch applied to a touch sensitive interface and a buy sweep order when the selection is a two point touch to the touch sensitive interface.

FIGS. 5C to 5E illustrates examples of order entry area configurations that may be utilized to initiate placement of an order. FIG. 5C illustrates one configuration of a trading interface (identified as trading interface 500B) including order entry areas overlapping each cell making up a column. For example, selection of a particular order entry area 526 in bid column 502 may initiate placement of an order to buy a default quantity at the value level aligned with the selected order entry area. In operation, when the user selects an order entry area 526 overlapping the cell containing the bid quantity “80” in the illustrated example, the trading device 210 sends an order to sell a default quantity of 5 displayed in the quantity field 520 (see FIG. 5A) at a price of “96300”.

FIG. 5C further illustrates another configuration of the trading interface 500C including an order entry area overlapping an entire column. For example, selection within a portion of the order entry area 528 overlapping the ask column 506 initiates placement of an order to sell a default quantity at the value level corresponding to the selected portion of the order entry area. In operation, when the user selects within the order entry area 528 at a location corresponding to the cell displaying the ask quantity “69” in the illustrated example, the trading device 210 sends an order to buy a default quantity of 5 displayed in the quantity field 520 at a price of “96450”.

FIG. 5D illustrates another configuration of a trading interface (identified as trading interface 500D) including order entry areas overlapping cells defined within one or more of the columns in the same row. For example, an order entry area 530 may overlap a row 512 containing cells within each of the columns 502 to 506. In operation, selection within any portion of the order entry area 530 overlapping the row 512 initiates placement of an order to either buy or sell a default quantity at a price of “96300”. Determination of the side (e.g., buy or sell) of the order may be based on the method of the selection (e.g., a left click to initiate a buy order and a right click to initiate a sell order) and/or the position at which the selection was made (e.g., within a portion of the order entry area overlapping the buy column 502, within a portion of the value column 504 closer to the ask column 506. In another example, a first order entry area 532 overlaps a first cell in column 502 and part of a second cell in column 504, and a second order entry area 534 overlaps part of the second cell in column 504 and a third cell in column 506. In another example, individual order entry areas 536, 538 and 540 overlap aligned cells in each of the columns 502, 504 and 506.

FIG. 5D further illustrates order entry areas overlapping other elements of the trading interface 500D and aligned with the value levels of the value column. For example, an order entry area 542 encompasses multiple “Buy” elements 544 where each element 544 is aligned with a value level of the value column 504. In operation, selection within the order entry area 542 initiates placement of an order to buy a default quantity of the tradeable object. The order is at the price associated with the value level aligned with the element 544 at the location of the selection. In another example, order entry areas 546 overlay each individual “Sell” element 548, where each element 548 is aligned with a value level of the value column 504. In operation, selection of an order entry area 546 aligned with the cell in the value column 504 displaying the price “96425” results in a sell order for a default quantity being sent at the value level associated with the aligned cell.

FIG. 5E illustrates another configuration of a trading interface (identified as trading interface 500E) including order entry areas overlapping elements not aligned with the value levels of the value column. For example, an order entry area 550 encompasses multiple “Buy” elements 552a-552c configured to display different pre-set quantity levels and the currently selected price level. In operation, selection of a value level corresponding to the cell displaying the price “96300” links the selected value level with the order entry area 550. Another selection of a portion of order entry area 550 overlaying the element 552b results in a buy order for a quantity of 5 being sent at the linked price. Similarly, individualized order entry areas 554 overlaying “Sell” elements 556 may be selected to initiate placement of a sell order at a pre-defined quantity associated with the corresponding element 556 at the linked price.

### VII. Non-Linear Tick Size Sequences

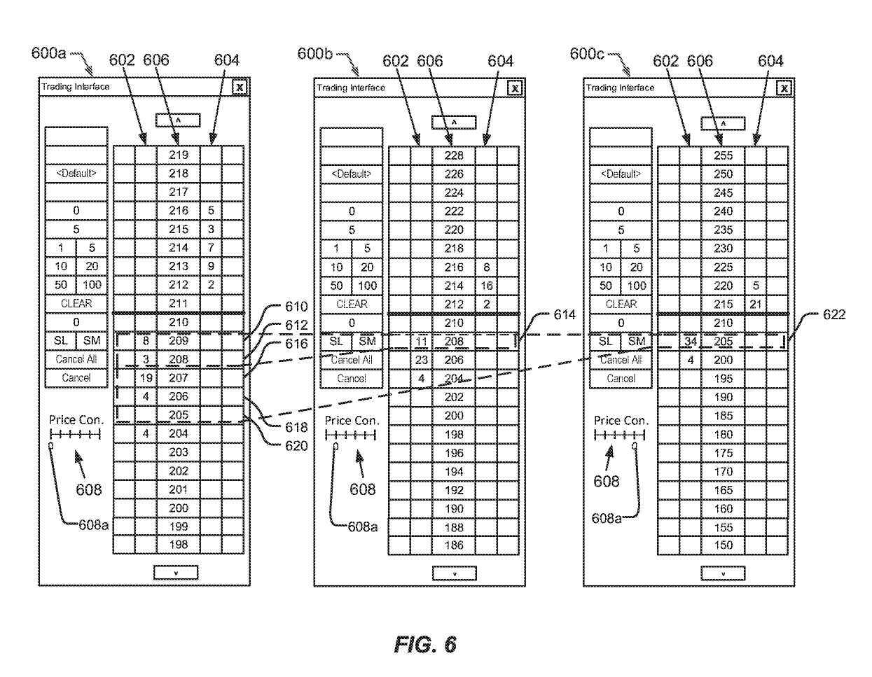

FIG. 6 illustrates another example graphical user interface or trading interface 600a displaying market data associated with a tradeable object. The trading interface 600a may be displayed on the trading device 110 of FIG. 1 and/or the trading device 210 of FIG. 2, for example, using a trading application including trading tools to process and/or organize market data. Trading tools may include, for example, MD TRADER®, X_TRADER®, ADL®, AUTOSPREADER®, and AUTOTRADER™, each provided by Trading Technologies. In the illustrated example of FIG. 6, the trading interface 600a (as well as the trading interfaces 600b, 600c) includes example values for illustrative purposes.

The trading interface 600a may display market data for any tradeable object or synthetic object (e.g., a tradeable object defined as part of a trading strategy). Column 602 displays the buy quantities and column 604 displays the ask quantities at corresponding values shown in value column 606. In some examples, the values in the value column 606 represent a price (e.g., in U.S. dollars, in Euros, in Yen, etc.). In other examples, the values in the value column 606 represent derived or calculated values that correspond to the tradeable object. In general, the tick size or increment of the values is calculated based on the smallest change in value in which the corresponding object can be traded. For example, in some markets, a tradeable object may have a tick size of $0.001 (i.e., a tenth of a penny). Therefore, if the inside market data is around $1, the values may be displayed as 999, 1000, 1001, 1002, 1003, etc. As disclosed herein, the values are typically displayed without decimal points (which may be a format or convention expected by a user).

In some instances, a trader may desire to add more precision (e.g., granularity) to the market data or may desire to condense the market data (e.g., for easier viewing). Price consolidation is a known technique that is used to condense the display of price information combining the values in a particular number of rows into one row or price level. In this technique, the bid and ask quantities for the particular number of rows are combined and displayed as a sum in the condensed row. For example, the trading interface 600a includes a price consolidation slider 608 and a consolidation button 608a. The price consolidation slider 608 includes a plurality of tick marks (e.g., tick increments or steps) that each represent a level of consolidation that is to be applied. For example, if the consolidation button 608a is moved to the second tick mark indicated on the price consolidation slider 608, as illustrated in trading interface 600b, then every two rows (e.g., price levels) are combined into one row. As a result, instead of ticking at every whole number, the market data ticks at every other number (e.g., 2, 4, 6, etc.), and the quantities in the bid and ask columns 602, 604 are summed into the cells at the new rows. In the first trading window 600a, the tick size or increment is one, so every value in the value column 606 is one from the previous value. However, in the second example trading interface 600b, two rows of the first trading interface 600a have been combined into one row or price level. Therefore, the quantities in the bid and ask columns 602, 604 have also been adjusted. For example, the quantity of 8 in row 610 (at a value of 209) and the quantity of 3 in row 612 (at a value of 208) in the bid column 602 of the first trading interface 600a have been combined to produce the quantity of 11 in row 614 (at a value of 208) in the second trading interface 600b. By moving the consolidation button 608a, a user can further combine three, four, five, etc. levels into one row. For example, in a third example trading interface 600c, the consolidation button 608 has been moved to consolidate five rows. Therefore, the tick size or increment is set to five. As shown, the quantities in the bid column 602 of rows 610, 612, 616, 618, 620 (at values 205-209) of the first trading interface 600b have been combined into row 622 (at a value of 205) in the third trading interface 600c. The price consolidation technique may also be used in reverse to expand the rows or price level. The price consolidation technique may be effective for condensing or expanding the range of values as shown in the trading interfaces 600a, 600b, and 600c.

However, in some instances, the price consolidation technique results in awkward and difficult-to-understand values that do not effectively reflect how a trader views ticking. Additionally, the calculated tick size for a trading strategy is typically a relatively small number and may not be an even multiple of a particular denomination of a currency system. For example, if the tick size for a trading strategy is calculated to be 1/256 of a dollar, and a trader desires to change the tick size to 1 cent (e.g., 1/100 of a dollar), there is no set number of rows that could be combined to produce the 1-cent increments. The price consolidation technique could be used to combine every two rows, which would change the tick size to 1/128, or every three rows, which would change tick size to 3/256. However, these resulting tick sizes are not 1-cent increments and are difficult to understand because they are not based on a scale or sequence (e.g., a currency system) as normally understood by a trader.

Further, the calculated tick size may result in highly condensed view where there are large quantities of bids/ask over a short range or the tick size may result in a large gaps between the next available bid/ask quantity, which may become difficult to view because of the space between the next available bid/ask quantity. As a result, a trader may have to scroll up or down through the interface to see the market depth and make trading decisions.

In certain embodiments, a trader may desire to adjust the tick size based on a scale or sequence that is non-linear (e.g., is not a multiple of the calculated tick size). For example, the U.S. currency system produces currency in the following denominations: 1 cent (a penny); 5 cents (a nickel); 10 cents (a dime); 25 cents (a quarter); 50 cents (a half-dollar); one dollar (a dollar bill); 5 dollars (a five dollar bill); 10 dollars (a ten dollar bill); 20 dollars (a twenty dollar bill); 50 dollars (a fifty dollar bill); or 100 dollars (a 100 dollar bill). The smallest tick size for a spread may not fall into an even category of these denominations. If a user attempts to use the price consolidation technique to consolidate the values at the prices levels, the user may end up with an unfamiliar and awkward tick size, as explained above.

In general, the example systems and methods disclosed herein enable a trading interface to display market data at a tick size based on a scaling factor that is selected from a tick size sequence or scale based on a plurality of non-linearly spaced or arranged scaling factors. The tick size sequence and/or one of the multiple scaling factors from the tick size sequence may be determined automatically or may be selected manually by a user. In some examples, a tick size sequence may correspond to available currency denominations for a certain currency system (e.g., the U.S. dollar, the Euro, the Yen, etc.). In such an example, the tick size sequence includes a plurality of non-linear scaling factors that correspond to the available denominations of the particular currency. The scaling factors may be used to change the tick size of the trading strategy. As such, the trading interface may display market data to a trader at a tick size that is more appropriate and understandable for trading the trading strategy, thereby enabling the trader to make better trading decisions.

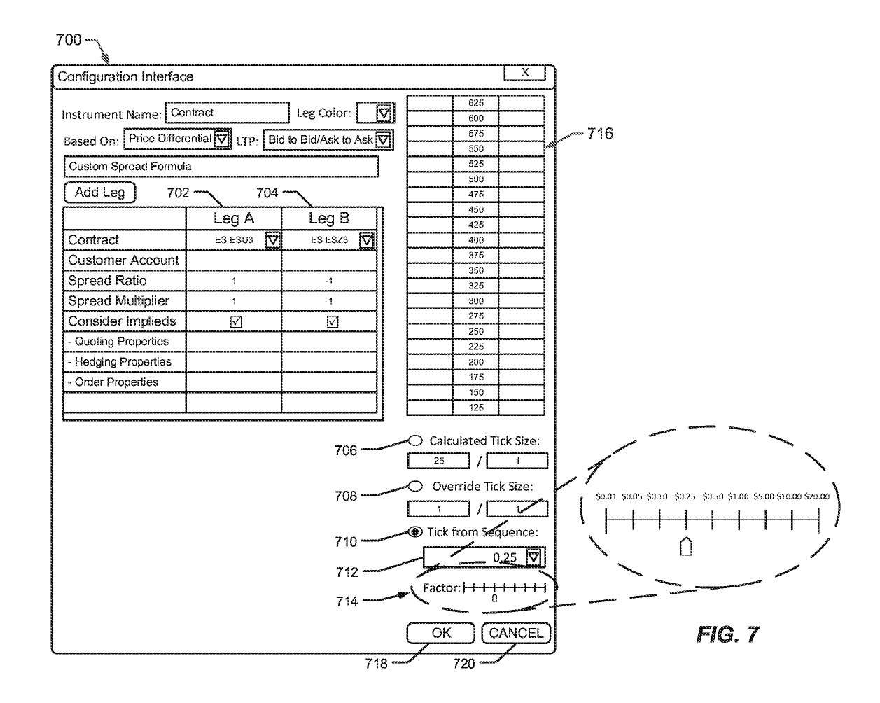

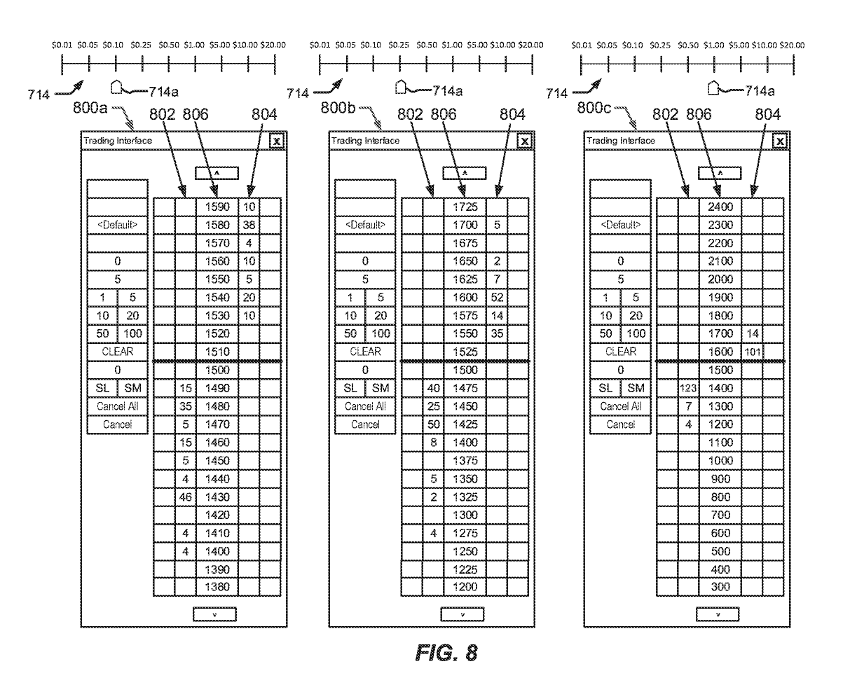

FIG. 7 illustrates an example configuration interface 700 (e.g., a configuration window, a configuration manager, a spread manager window, a trading tool, etc.) that may be used to configure and define a trading strategy and in which certain embodiments may be employed. The example configuration interface 700 may be used to configure a trading interface such as the trading interface 600a of FIG. 6. The example configuration interface 700 may be displayed on the trading device 110 of FIG. 1 and/or the trading device 210 of FIG. 2 using a trading application including trading tools to process and/or organize market data. Trading tools may include, for example, MD TRADER®, X_TRADER®, ADL®, AUTOSPREADER®, and AUTOTRADER™, each provided by Trading Technologies. The trading devices 110, 210 provide a trading interface (e.g., a graphical user interface) to enable a user to view market data and communicate trade orders, trade actions with an electronic exchange, define trading strategies, define a trading interface (e.g., the example trading interfaces 600a-600c of FIG. 6), etc.

In the illustrated example, the configuration interface 700 may be used to define a trading strategy (e.g., spread trading strategy) such as the trading strategy 410 of FIG. 4 and/or configure a trading strategy to be displayed. After the trading strategy is configured and/or defined, market data (e.g., spread data) may be displayed in a trading interface (e.g., the trading interface 600a of FIG. 6) where a trader can then interact with the trading strategy (e.g., buy, sell, view market data, etc.). The trading strategy may have one or more quoting legs and one or more leaning legs, for example. The legs are associated with respective tradeable objects that are to be bought or sold as defined by the trading strategy. In the illustrated example, two legs have been added to the configuration interface 700. Specifically, a first leg 702 (“Leg A”) and a second leg 704 (“Leg B”) have been selected as part of the trading strategy. The first and second legs 702, 704 may correspond to, for example, two of the legs 420a to 420n of the trading strategy 410 in FIG. 4. One of the legs 702, 704 may be a quoting leg and the other of the legs 702, 704 may be a lean leg, for example. In the illustrated example, the configuration interface 700 includes a plurality of spread setting parameters (e.g., categories, criteria, etc.) that can be set by a user to customize the spread data feed. The spread setting parameters control the behavior of the spread as it is generated and/or displayed and/or traded, depending on the particular parameter. In the illustrated example, the categories of parameters include a contract name (e.g., the tradeable object associated with the respective leg), a customer account, a spread ratio, a spread multiplier, consider implieds, and a plurality of expandable parameter menus such quoting properties, hedging properties and order properties. In other examples, more or fewer categories of spread setting parameters may be included. Other spread setting parameters may include, for example, active quoting, adjust for market depth, offset with, pay-up ticks, use cancel/replace rather than change and/or price reasonability check on leg. Although only two legs are illustrated in the configuration interface 700, it is understood more legs (e.g., quoting legs and/or lean legs) may be added to the configuration interface 700 to define the trading strategy.

In the illustrated example, the configuration interface 700 includes a first tick size option 706 (“Calculated Tick Size”) that displays a calculated tick size that is to be used to display the market data of the trading strategy. The calculated tick size option 706 may be used as a default. As disclosed herein, the tick size of the trading strategy may be calculated based on the smallest available value of the trading strategy, which is a function of the market data associated with the legs 702, 704. To override the calculated tick size, and manually enter a desired tick size (e.g., via a ratio), the configuration interface 700 includes a second tick size option 708 (“Override Tick Size”), which allows a user to manually enter a desired tick size or increment.

To enable the trading strategy to be displayed using tick sizes from a tick size sequence having a plurality of non-linear scaling factors (e.g., tick sizes), the example configuration interface 700 includes a third tick size option 710 (“Tick from Sequence”). When the third tick size option 710 is activated, a tick size sequence having a plurality of non-linear scaling factors is determined. Once the tick size sequence is determined, a scaling factor (e.g., a tick unit, an increment, etc.) from the tick size sequence may be selected to affect (e.g., adjust, modify, change, recalculate) the tick size (e.g., the initially calculated tick size) of the trading strategy.

In some examples, the tick size sequence is automatically determined (e.g., via the example systems disclosed herein). In such an example, the user may then manually select a scaling factor from the determined tick size sequence. In other examples, the user may manually select the tick size sequence to be used (e.g., from a list of available tick size sequences). For example, the tick from sequence option 710 also may include a dropdown menu with a plurality of available tick size sequences that the user can select. Each of the tick size sequences may have a plurality of non-linear scaling factors associated with the respective tick size sequence. For example, a first tick size sequence may correspond to the U.S. dollar currency system (e.g., with scaling factors corresponding to the available denominations of the U.S. dollar), while a second tick size sequence may correspond to the Euro currency system (e.g., with scaling factors corresponding to the available denominations of the Euro).

In some examples, to determine the tick size sequence to be used, a user may select or designate one of the legs of the trading strategy as having a tick size from a preferred tick size sequence (e.g., a particular currency system). For example, if a user selects or designates the second leg 704, and the second leg 704 has a tick size based on the U.S. currency system (e.g., 1 cent or $0.01), then a tick size sequence based on the U.S. currency system may be selected. In some examples, if all of the legs have tick sizes that are associated with the same tick size sequence (e.g., from the same currency system), then a tick size sequence that is based on the common tick size sequence of the legs may be selected. For example, if the first leg 702 has a tick size of 5 cents ($0.05), which is associated with the U.S. dollar currency system, and the second leg 704 has a tick size of 50 cents ($0.50), which is also associated with the U.S. dollar currency system, then a tick size sequence that is based on the U.S. currency system may be selected.

In some examples, if there is only one quoting leg, then a tick size sequence is selected that is based on the tick size of the single quoting leg. If there is more than one quoting leg, and all of the quoting legs have tick sizes that are associated with common tick size sequence (e.g., from the same currency system), then a tick size sequence may be selected that is based on the common tick size sequence of the quoting legs. Otherwise, if all of the quoting legs do not have tick sizes from a common tick size sequence, then a tick size sequence may be selected that is based on a first quoting leg as defined in the trading strategy (e.g., as in the order the quoting legs are entered). In other examples, selection of a tick size sequence may be based on other determinations.

Once a tick size sequence has been determined or selected, the tick size sequence is retrieved (e.g., from a database of available tick size sequences). The tick size sequence has a plurality of non-linear scaling factors that correspond to tick-sizes that a trader may select to affect the tick size of the trading strategy. In some examples, the tick size sequence is associated with a known currency system, and the scaling factors within the tick size sequence correspond to the available denominations of the currency system. For example, a tick size sequence may be based on the U.S. dollar currency system (“USD”), and the scaling factors of the tick size sequence may correspond to the available denominations of U.S. dollar currency system: 1 cent (a penny); 5 cents (a nickel); 10 cents (a dime); 25 cents (a quarter); 50 cents (a half-dollar); 1 dollar (a 1 dollar bill); 5 dollars (a 5 dollar bill); 10 dollars (a 10 dollar bill); 20 dollars (a 20 dollar bill); 50 dollars (a 50 dollar bill); and 100 dollars (a 100 dollar bill). As another example, a tick size sequence may be based on the Euro currency system, and the scaling factors of the tick size sequence may correspond to the available denominations of the Euro: 1 cent; 2 cents; 5 cents; 10 cents; 20 cents; 50 cents; 1 Euro; 2 Euro; 5 Euro; 10 Euro; 20 Euro; 50 Euro; 100 Euro; 200 Euro; and 500 Euro. In yet another example, a tick size sequence may be based on the yen currency system, and the scaling factors of the tick size sequence may correspond to the available denominations of the yen: 1 yen; 5 yen; 10 yen; 50 yen; 100 yen; 500 yen; 1,000 yen; 2,000 yen; 5,000 yen; and 10,000 yen. Any of these example sequences may include more or fewer scaling factors (e.g., the tick size sequence based on the USD may also include a scaling factor of $2.50). In some examples, a plurality of tick size sequences may be available, where each corresponds to a different currency system.

In some examples, determinations for a tick size sequence may be based on scaling factors other than currency. In one example, the tick size sequence may be based on a volume measurement (e.g., gallons, liters, cubic meters) relevant to the tradeable object and/or the contract utilized to trade the tradeable objects. For example, NYMEX Light Sweet Crude Oil futures prices are quoted in dollars and cents per barrel and are traded in lot sizes of 1000 barrels (42000 gallons). In certain embodiments, a user may wish to define scaling factors based on different lot sizes that might be of interest. An example tick size sequence might include scaling factors based on a number of barrels. For example, a tick size sequence may represent: a single barrel (1), five barrels (5), fifty barrels (50), one hundred barrels (100), five-hundred barrels (500), and one thousand barrels (1000). Another example tick size sequence might include scaling factors based on volume units such as gallons. For example, a tick size sequence may represent: forty-two gallons, fifty-five gallons, four hundred twenty (420) gallons, five-hundred fifty (550) gallons, forty-two hundred (4200) gallons, and fifty-five hundred (5500) gallons.

In other examples, the tick size sequence may be based on a measurement or characteristic relevant to the tradeable object and/or the contract utilized to trade the tradeable objects. For example, certain agricultural future contracts are traded in units including bushels, pounds, and tons. Agricultural futures contracts such as: Alberta Barley futures are quoted in Canadian dollars and cents and are traded in lots sized in twenty (20) ton trading units; Soybean oil is quoted in dollars and cents per barrel and are traded in lots sized in sixty thousand (60,000) pound trading units; and South American Soybeans are quoted in dollars and cents and are traded in lots sized in five thousand (5000) bushel trading units. Example tick size sequences for the agricultural future contracts may be based on fractions, multiples and other measurements of bushels, pounds, and/or tons. Identification of the individual scaling factor values may be based on known units and/or factors of trade (e.g., fifty-five gallons in a barrel, two-thousand pounds in a ton) and other measurements of interest to a user or specific trading strategy.

In certain embodiments, the tick size sequence may be established utilizing different measurements or characteristics from multiple contracts for tradeable objects. For example, a tick size sequence could include scaling factors based on different measurements or characteristics of two or more tradeable objects of interest. One example tick size sequence may include scaling factors based on bushels, gallons and tons in an attempt to describe a soybean crush spread that includes soybeans, soybean oil and soybean meal.

In some examples, to select a scaling factor from the selected or determine tick size sequence, the example configuration interface 700 includes a scaling factor menu 712, which is displayed via a dropdown menu. The scaling factor menu 712 includes the available scaling factors that are part of the corresponding selected tick size sequence. Additionally or alternatively, the example configuration interface 700 may include a scaling factor slider 714 and a scaling button 714a, which includes tick marks (e.g., tick increments or steps) that correspond to the scaling factors of the respective tick size sequence. Although the tick marks are spaced evenly from each other, the scaling factors that are represented by the tick marks are based on a non-linear scale (e.g., 10, 25, 50, 100, etc.).

An enlarged view the scaling factor slider 714 is illustrated in FIG. 7. The tick marks of the scaling factor slider 714 represent the scaling factors of the selected or determined tick size sequence. For example, if the tick size sequence was determined to be based on the U.S. dollar currency system, then the tick marks the scaling factor slider 714 may represent the available denominations of U.S. dollar currency system (e.g., 1 cent ($0.01), 5 cents ($0.05), 10 cents ($0.10), 25 cents ($0.25), 50 cents ($0.50), 1 dollar ($1.00), etc.). If the tick size sequence was determined to be based on the Euro currency system, for example, then the tick marks of the scaling factor slider 714 may represent the available denominations of the Euro currency system (e.g., 1 cent ( [symbol] 0.01), 2 cents ( [symbol] 0.02), 5 cents ( [symbol] 0.05), 10 cents ( [symbol] 0.10), 20 cents ( [symbol] 0.20), 50 cents ( [symbol] 0.50), 1 Euro ( [symbol] 1.00), etc.). In another example, the Yen currency system (e.g., 1 yen (¥1), 5 yen (¥5), 10 yen (¥10), 50 yen (¥50), 100 yen (¥100), etc.). Therefore, the scaling factors, which may correspond to available denominations of a particular currency, enable the trading strategy to be displayed at tick sizes that are more natural and understandable to a trader. In some examples, the scaling factor denominations are displayed adjacent the corresponding tick marks. However, in other examples, the scaling factor denominations may not be displayed adjacent the tick marks. The example scaling factor slider 714 may include more or less tick marks depending on the amount of scaling factors available for a given tick size sequence. The tick from sequence options 710 enables a user to quickly and easily select a non-linear tick size sequence and corresponding scaling factor that more appropriately displays the market data for a desired trading strategy. In some examples, if a scaling factor is not selected, the lowest or smallest scaling factor (e.g., which may correspond to the calculated tick size) may be selected automatically.

In the illustrated example, the configuration interface 700 includes a tick size preview window 716 that shows a preview of a trading interface at an example tick size. Once the trading strategy is defined and a tick size option is selected, a user may select a button 718 labeled “OK” to accept the trading strategy. After selecting the button 718, one or more trading interfaces (e.g., trading windows) may be displayed such as the spread window and/or leg windows (e.g., a leg window for each of the quoting legs and lean legs). A user may instead click a button 720 labeled “CANCEL” to cancel the trading strategy.

FIG. 8 illustrates three example trading interfaces 800a, 800b, 800c that are displaying market data for a trading strategy at different scaling factors that have been selected from a tick size sequence. For illustrative purposes, a tick size sequence that based on the U.S. dollar currency system is utilized. However, as disclosed herein, different tick size sequences having different non-linear scaling factors may be implemented instead. In the first trading interface 800a, the scaling button 714a indicates a scaling factor that corresponds to 10 cents ($0.10) has been selected, as illustrated in the example scaling factor slider 714 shown above the first trading interface 800a. The example scaling factor slider 714 is used in the configuration interface 700 of FIG. 7 to configure the display of the market data in the trading interface 800a. The example scaling factor slider 714 is not shown in the example first trading interface 800a. As a result, the values in the value column 806 represent values in U.S. dollars (which are typically displayed without the decimal points), and the tick size or increment displayed is 10 cents ($0.10). In the second trading interface 800b, the scaling button 714a indicates a scaling factor that corresponds to 25 cents ($0.25) has been selected, as illustrated in the example scaling factor slider 714 shown above the second trading interface 800b (which is used in the configuration interface 700 of FIG. 7). Again, the values in the value column 806 represent values in U.S. dollars, and the tick size or increment in this example is 25 cents ($0.25). In the third trading interface 800c, the scaling button 714a indicates a scaling factor that corresponds to 1 dollar ($1.00) has been selected, as illustrated in the example scaling factor slider 714 shown above the third trading interface 800c (which is used in the configuration interface 700 of FIG. 7). Therefore, the values in the value column 806 represent values in U.S. dollars, and the tick size or increment in the example is 1 dollar ($1.00). In some examples, price consolidation may then be performed to combine a number of rows or price levels together. For example, the price consolidation slider 608 and the consolidation button 608a (as illustrated in FIG. 6) may be provided in the example trading interface 800a to consolidate or expand the rows. In other examples, a price consolidation option may be provided in the configuration interface 700 of FIG. 7, such that the tick size sequence, the associated scaling factor and the price consolidation level may all be configured or defined and implemented as part of the trading strategy. In some examples, the scaling factor menu 712 and/or the scaling factor slider 714 are displayed in the trading interface 800a, whereby the scaling factor may be adjusted without using the configuration interface 700.

As illustrated in FIG. 8, the scaling factors (e.g., the tick sizes displayed) of the example tick size sequence are based on a non-linear scale. Using the example tick size sequence with the non-linear scaling factors enables a trader to quickly and easily adjust the tick size of the trading strategy to other tick sizes that are associated with a tick size sequence.

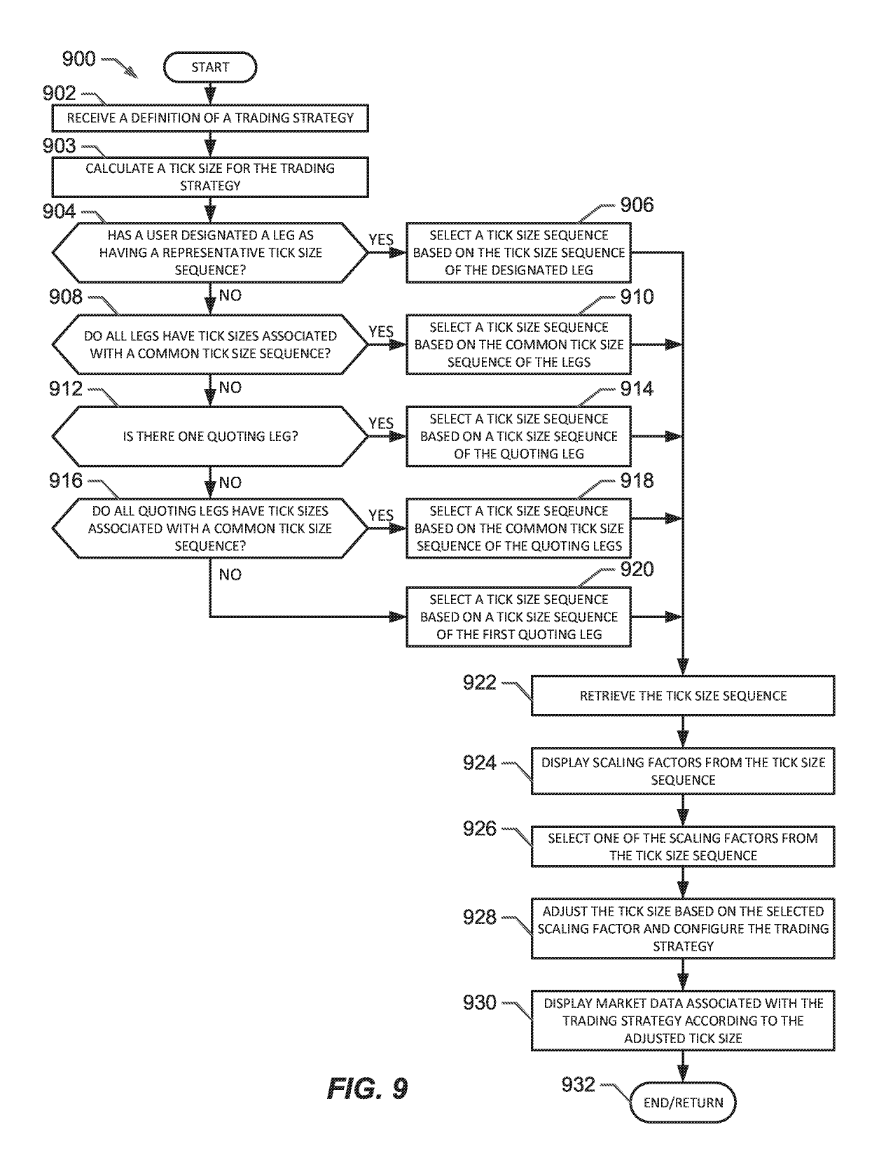

FIG. 9 illustrates a flow diagram of an example process or method 900 to define a trading strategy and determine a tick size sequence to be used for adjusting a calculated tick size that market data related to the trading strategy is to be displayed. The example method 900 includes receiving a definition of a trading strategy (block 902), such as a spread trading strategy, and calculating a tick size (e.g., a first tick size) for the trading strategy (block 903). The definition of the trading strategy includes which legs of the trading strategy are associated with which tradeable objects. As disclosed herein, a trading strategy may have one or more quoting legs and one or more leaning legs, and each of the legs are associated with a tradeable object that is to be bought or sold as defined by the trading strategy. The trading strategy may be defined using, for example, the configuration interface 700 of FIG. 7. For example, in the configuration interface 700, one or more legs of the trading strategy may be selected and the spread setting parameters may also be selected. In the illustrated example of FIG. 7, the first lean leg 702 and the second lean leg 704 have been defined as part of the spread trading strategy.

The example method 900 includes determining whether a user has designated or selected a leg of the trading strategy as having a representative (e.g., preferred) tick size sequence (and/or tick size from a representative tick size sequence) (block 904). If a user has selected or designated one of the legs as having a representative tick size sequence, then a tick size sequence is selected that is based on the tick size sequence of the designated leg (block 906). A representative tick size sequence may be a currency system. For example, if a user designates a leg that has a tick size based on the U.S. dollar currency system (e.g., 1 cent or $0.01), then a tick size sequence based on the U.S. currency system may be selected (e.g., the tick size sequence may include scaling factors that correspond to the available denominations of the U.S. dollar currency system).

If it is determined that a user has not designated or selected one of the legs has having a representative tick size sequence (block 904), the example method 900 includes determining whether all of the legs of the trading strategy have tick sizes or scaling factors that are associated with a same or common tick size sequence (e.g., from the same currency system) (block 908). If all of the legs of the trading strategy do have tick sizes associated with the same tick size sequence, then a tick size sequence is selected that is based on the common tick size sequence of the legs (block 910). For example, if there are two legs defined in the trading strategy, and the first leg has a tick size of 5 cents of the Euro, and a second leg has a tick size of 50 cents of the Euro, then a tick size sequence that is based on the Euro currency system is selected.

If it is determined that all of the legs of the trading strategy do not have tick sizes associated with a common tick size sequence (block 908), the example method 900 includes determining whether there is only one quoting leg as part of the trading strategy (block 912). If there is only one quoting leg, then a tick size sequence is selected that is based on the tick size or scaling factor used by the single quoting leg (block 914). If there is more than one quoting leg, then the example method 900 includes determining whether all of the quoting legs have tick sizes or scaling factors that are associated with a same or common tick size sequence (block 916). If all of the quoting legs do have tick sizes associated with the same tick size sequence, then a tick size sequence is selected that is based on the common tick size sequence of the quoting legs (block 918). If it is determined that all of the quoting legs do not have tick sizes associated with a common tick size sequence, the example method 900 includes selecting a tick size sequence that is based on a tick size sequence from the first quoting leg defined in the trading strategy (e.g., as in the order the quoting legs are entered into the definition) (block 920). In some examples, additional or alternative determinations may be used to select a tick size sequence.

The example method 900 includes retrieving the tick size sequence that has been determined or selected (block 922). In some examples, the tick size sequence is retrieved from a database of tick size sequences. The tick size sequence includes a plurality of non-linear scaling factors (e.g., tick sizes) that may be used to adjust the tick size of the trading strategy (e.g. the initially calculated tick size of the trading strategy or another tick size of the trading strategy). For example, a tick size sequence may be based on a known currency system, and the scaling factors of the tick size sequence may correspond to the available denominations of the currency system. The example method 900 includes displaying the scaling factors from the retrieved tick size sequence (block 924). The scaling factors correspond to tick sizes or increments in which the values of the trading strategy are to be displayed. For example, if the tick size sequence is U.S. dollar currency system, then the scaling factors are the available denominations of the U.S. dollar (e.g., 1 cent (a penny), 5 cents (a nickel), 10 cents (a dime), 25 cents (a quarter), 50 cents (a half dollar), 1 dollar (a 1 dollar bill), etc.). The example scaling factors of the tick size sequence may be displayed via a selectable menu. For example, in the configuration interface 700 of FIG. 7, the scaling factors of the associated tick sizes sequence may be display in the scaling factor menu 712 and/or by representation in the scaling factor slider button 714.

The example method 900 includes selecting one of the scaling factors from the tick size sequence (block 926). In some examples, a scaling factor is selected automatically (e.g., by default). For example, the smallest scaling factor from the tick size sequence may be automatically selected. In other examples, a user may select a scaling factor to be used. For example, as illustrated in the configuration interface 700 of FIG. 7, a user may select one of the scaling factors using the dropdown menu 714 and/or the slider button 716.

The example method 900 includes adjusting the tick size (e.g., the calculated tick size from block 903) to a new tick size (e.g., a second tick size) based on the selected scaling factor and configuring the trading strategy (block 928). For example, if the calculated tick size was 1/256 of a U.S. dollar, and a scaling factor of 25 cents ($0.25) is selected from a tick size sequenced associated with the U.S. dollar currency system, then the calculated tick size (e.g., a first tick size) is adjusted to $0.25 (e.g., a second tick size). The example method 900 includes displaying the market data associated with the trading strategy according to the adjusted tick size (e.g., the second tick size) (block 930). The market data may be displayed in a trading interface such as the trading interface 800a of FIG. 8. In some examples, after the market data for the trading strategy is display, another scaling factor from the tick size sequence may be selected and the display of the trading strategy may be adjusted accordingly (e.g., as illustrated between the trading interfaces 800a, 800b, 800c of FIG. 8). In some examples, a tool may be displayed in the trading interface to change the scaling factor on the fly. For example, the scaling factor menu 712 and/or the scaling factor slider button 714 may be displayed in the trading interface.

The example method 900 may end when another trading strategy is to be defined or return when the trading strategy is to be modified (e.g., to change the tick size to another tick size based on a scaling factor from the selected tick size sequence or another tick size sequence) (block 932). In some examples, the price consolidation technique may then be used to further consolidation multiple rows or levels of values. In some examples, a price consolidation tool (e.g., the price consolidation slider 608) is displayed in the trading interface, which enables the user to apply the price consolidation technique. In other examples, the price consolidation values may be set in the example configuration interface 700, prior to viewing the market data in the trading interface.

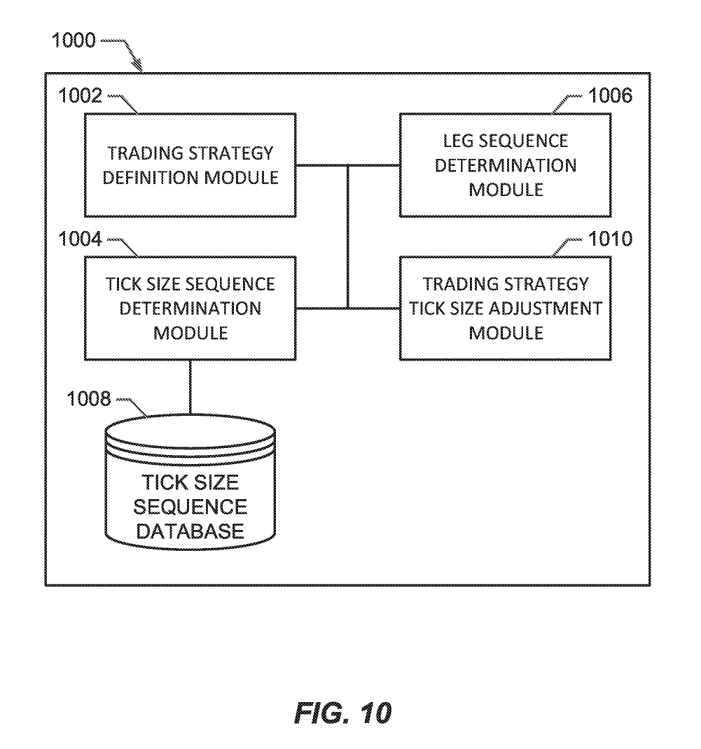

FIG. 10 illustrates a block diagram of an example system 1000 that may implement and/or execute the example method 900 of FIG. 9 and which may be used to implement the example configuration interface 700 of FIG. 7 and/or the example trading interfaces 800a-800c of FIG. 8. In some examples, the system 1000 is implemented as part of the trading system 200 of FIG. 2 such as part of software (or an application) associated with the trading device 210 and/or the gateway 220. For example, the system 1000 may be implemented as part of an automated trading tool or trading interface used by the trading device 210. In some examples, the system 1000 is implemented as computer implemented code or instructions operable independent of software associated with the trading device 210 and/or the gateway 220 of FIG. 2. In some examples, the features and functionality of the system 1000 may be implemented in hardware operable in connection with the trading device 210 and/or the gateway 220.

The example system 1000 includes a trading strategy definition module 1002 to receive and/or define a trading strategy. As disclosed herein, a definition of a trading strategy (e.g., a spread trading strategy) may include one or more quoting legs and one or more lean legs, where each of the legs is associated with a tradeable object that is to be bought or sold (e.g., at an exchange). In some examples, the trading strategy definition module 1002 receives the definition from a user who selects the quoting leg(s) and the leaning leg(s). For example, in the configuration interface 700 of FIG. 7, a user may select one or more legs and which tradeable objects or contracts are associated with each of the legs. In some examples, the trading strategy definition module 1002 calculates an initial tick size for the trading strategy.

The example system 1000 includes a tick size sequence determination module 1004 to determine which one of a plurality of tick size sequences are to be used. In some examples, a user may select a tick size sequence from a plurality of tick size sequences. In other examples, the tick size determination module 1004 may automatically determine which tick size sequence is to be used. For example, as disclosed herein, if a user has designated one of the legs as having a representative tick size sequence, then the tick size sequence determination module 1004 may select a tick size sequence based on the tick size sequence of the designated leg. A leg sequence determination module 1004 is provided to analyze a tick size or scaling factor associated with one or more of the legs to determine a tick size sequence (e.g., a currency system) associated with the respective leg. In some examples, if all of the legs of the trading strategy having tick sizes associated with a same or common tick sizes sequence (e.g., determined by the leg sequence determination module 1006), the tick size sequence determination module 1004 selects a tick size sequence based on the common tick size sequence of the all of the legs. In some examples, if there is only one quoting leg, the tick size sequence determination module 1004 selects a tick size sequence based on a tick size sequence of the one leg (e.g., as determined by the leg sequence determination module 1006). In some examples, if there is more than one quoting leg, the leg sequence determination module 1006 determines the tick size sequences associated with each of the legs based on the tick sizes of the respective legs. If there is a common tick size sequence amongst the quoting legs, the tick size sequence determination module 1004 may select a tick size sequence that is based on the common tick size sequence of the quoting legs. Otherwise, in some examples, the tick size sequence determination module 1004 may select a tick size sequence based on a tick size sequence of a first quoting leg (e.g., as determined by the leg sequence module 1006). The first quoting leg is the first quoting leg defined or selected in the definition of the trading strategy.

In the illustrated example of FIG. 10, a tick size sequence database 1008 is provided, which stores a plurality of available tick size sequence and the associated scaling factors of the respective tick size sequences. In some examples, the tick size sequence database 1008 may be located remotely and accessed via a network.

Once a tick size sequence and a scaling factor from the tick size sequence have been selected, a trading strategy adjustment module 1010 adjusts the tick size (e.g., the initially calculated tick size) of the trading strategy to a new tick size, which is then used when displaying the market data for the trading strategy. For example, if the calculated tick size is 1/256 of a U.S. dollar and a scaling factor of 25 cents ($0.25) is selected, then the tick size is adjusted to $0.25 and, thus, the market data is displayed at 25 cent increments in the trading interface.

Some of the described figures depict example block diagrams, systems, and/or flow diagrams representative of methods that may be used to implement all or part of certain embodiments. One or more of the components, elements, blocks, and/or functionality of the example block diagrams, systems, and/or flow diagrams may be implemented alone or in combination in hardware, firmware, discrete logic, as a set of computer readable instructions stored on a tangible computer readable medium, and/or any combinations thereof, for example.

The example block diagrams, systems, and/or flow diagrams may be implemented using any combination of application specific integrated circuit(s) (ASIC(s)), programmable logic device(s) (PLD(s)), field programmable logic device(s) (FPLD(s)), discrete logic, hardware, and/or firmware, for example. Also, some or all of the example methods may be implemented manually or in combination with the foregoing techniques, for example.

The example block diagrams, systems, and/or flow diagrams may be performed using one or more processors, controllers, and/or other processing devices, for example. For example, the examples may be implemented using coded instructions, for example, computer readable instructions, stored on a tangible computer readable medium. A tangible computer readable medium may include various types of volatile and non-volatile storage media, including, for example, random access memory (RAM), read-only memory (ROM), programmable read-only memory (PROM), electrically programmable read-only memory (EPROM), electrically erasable read-only memory (EEPROM), flash memory, a hard disk drive, optical media, magnetic tape, a file server, any other tangible data storage device, or any combination thereof. The tangible computer readable medium is non-transitory.

Further, although the example block diagrams, systems, and/or flow diagrams are described above with reference to the figures, other implementations may be employed. For example, the order of execution of the components, elements, blocks, and/or functionality may be changed and/or some of the components, elements, blocks, and/or functionality described may be changed, eliminated, sub-divided, or combined. Additionally, any or all of the components, elements, blocks, and/or functionality may be performed sequentially and/or in parallel by, for example, separate processing threads, processors, devices, discrete logic, and/or circuits.

While embodiments have been disclosed, various changes may be made and equivalents may be substituted. In addition, many modifications may be made to adapt a particular situation or material. Therefore, it is intended that the disclosed technology not be limited to the particular embodiments disclosed, but will include all embodiments falling within the scope of the appended claims.

What is claimed is:

1. A method comprising:
receiving, via a computing device, a definition of a trading strategy, the definition including two or more legs that correspond to respective tradeable objects offered at an exchange;
calculating, via the computing device, a first tick size for the trading strategy;
determining, via the computing device, a tick size sequence to be used to modify the first tick size of the trading strategy, the tick size sequence having a plurality of scaling factors;
selecting, via the computing device, one of the plurality of scaling factors of the tick size sequence;
adjusting, via the computing device, the first tick size to a second tick size based on the selected scaling factor; and
displaying market data associated with the trading strategy in a trading interface according to the second tick size.

2. The method of claim 1, wherein the plurality of scaling factors are non-linear.

3. The method of claim 1, wherein the tick size sequence is a first tick size sequence and the plurality of scaling factors is a first plurality of scaling factors, and wherein determining the first tick size sequence includes selecting the first tick size sequence from a plurality of available tick size sequences includes a second tick size sequence having a second plurality of scaling factors different than the first plurality of scaling factors.

4. The method of claim 1, wherein determining the tick size sequence includes determining whether a user has designated one of the legs of the definition as having a representative tick size sequence, and if the user has designated one of the legs, the tick size sequence is based on a tick size sequence of the designated leg.

5. The method of claim 1, wherein determining the tick size sequence includes determining whether all of the legs of the definition have scaling factors associated with a common tick size sequence, and if all of the legs have scaling factors associated with a common tick size sequence, the tick size sequence is based on the common tick size sequence of the legs.

6. The method of claim 1, wherein determining the first tick size sequence includes determining whether there is only one quoting leg in the definition, and if there is only one quoting leg in the definition, the first tick size sequence is based on a tick size sequence of the one quoting leg.

7. The method of claim 1, wherein the tick size sequence is based on a currency system and the plurality of scaling factors correspond to available denominations of the currency system.

8. A system comprising:
a computing device configured to:
receive a definition of a trading strategy, the definition includes two or more legs that correspond to respective tradeable objects offered at an exchange;
calculate a first tick size for the trading strategy;
determine a tick size sequence to be used to modify the tick size of the trading strategy, the tick size sequence having a plurality of non-linear scaling factors;
select one of the plurality of scaling factors of the tick size sequence; and
adjust the first tick size to a second tick size based on the selected scaling factor; and
a trading interface to display market data associated with the trading strategy according to the second tick size.

9. The system of claim 8, wherein the plurality of scaling factors are non-linear.

10. The system of claim 8, wherein the tick size sequence is a first tick size sequence and the plurality of scaling factors is a first plurality of scaling factors, and wherein a plurality of available tick size sequences are to be displayed to the user via the trading interface, the plurality of available tick size sequences including a second tick size sequence having a second plurality of scaling factors different than the first plurality of scaling factors.

11. The system of claim 8, wherein the computing device is to determine the tick size sequence by determining whether a user has designated one of the legs of the definition as having a representative tick size sequence, and if the user has designated one of the legs, the tick size sequence is based on a tick size sequence of the designated leg.

12. The system of claim 8, wherein the computing device is to determine the tick size sequence by determining whether all of the legs of the definition have scaling factors associated with a common tick size sequence, and if all of the legs have scaling factors associated with a common tick size sequence, the tick size sequence is based on the common tick size sequence of the legs.

13. The system of claim 8, wherein the computing device is to determine the first tick size sequence by determining whether there is only one quoting leg in the definition, and if there is only one quoting leg in the definition, the first tick size sequence is based on a tick size sequence of the one quoting leg.

14. The system of claim 8, wherein the tick size sequence is based on a currency system and the plurality of scaling factors correspond to on available denominations of the currency system.

15. A tangible computer readable storage device comprising instructions that, when executed, cause a computing device to at least:
receive a definition of a trading strategy, the definition including two or more legs that correspond to respective tradeable objects offered at an exchange;
calculate a first tick size for the trading strategy;
determine a tick size sequence to be used to modify a tick size of the trading strategy, the tick size sequence having a plurality of scaling factors;
select one of the plurality of scaling factors of the tick size sequence;
adjust the first tick size to a second tick size based on the selected scaling factor; and
display market data associated with the trading strategy in a trading interface according to the second tick size.

16. The tangible computer readable storage device of claim 15, wherein the plurality of scaling factors are non-linear.

17. The tangible computer readable storage device of claim 15, wherein the instructions, when executed, cause the computing device to determine the tick size sequence by determining whether a user has designated one of the legs of the definition as having a representative tick size sequence, and if the user has designated one of the legs, the tick size sequence is based on a tick size sequence of the designated leg.

18. The tangible computer readable storage device of claim 15, wherein the instructions, when executed, cause the computing device to determine the tick size sequence by determining whether all of the legs of the definition have scaling factors associated with a common tick size sequence, and if all of the legs have scaling factors associated with a common tick size sequence, the tick size sequence is based on the common tick size sequence of the legs.

19. The tangible computer readable storage device of claim 15, wherein the instructions, when executed, cause the computing device to determine the first tick size sequence by determining whether there is only one quoting leg in the definition, and if there is only one quoting leg in the definition, the first tick size sequence is based on a tick size sequence of the one quoting leg.

20. The tangible computer readable storage device of claim 15, wherein the tick size sequence is based on a currency system and the plurality of scaling factors correspond to available denominations of the currency system.
